(19) United States
(12) Patent Application Publication
(10) Pub. No.: US 2026/0040268 A1
(43) Pub. Date: Feb. 5, 2026

(54) METHOD FOR CONTROLLING POSITIONING INTEGRITY AND APPARATUS

(71) Applicant: HUAWEI TECHNOLOGIES CO., LTD., Shenzhen (CN)

(72) Inventors: Mengting Liu, Beijing (CN); Su Huang, Shanghai (CN); Junren Chang, Beijing (CN); Xi Xie, Beijing (CN)

(21) Appl. No.: 19/351,945

(22) Filed: Oct. 7, 2025

Related U.S. Application Data
(63) Continuation of application No. 17/953,774, filed on Sep. 27, 2022, now Pat. No. 12,464,486.
Application No. 17/953,774 is a continuation of application No. PCT/CN2020/082225, filed on Mar. 30, 2020.

(51) Int. Cl. H04W 64/00

(52) U.S. Cl. CPC H04W 64/00

(57) ABSTRACT

A method for controlling positioning integrity includes: A location management device (103) receives a first message sent by a terminal device (101), where the first message includes a first parameter set, the first parameter set includes measurement information and/or error information that are/is related to location information of the terminal device (101), and the error information is related to the positioning integrity. The location management device (103) obtains a first positioning result based on the first parameter set and/or positioning assistance data, where the first positioning result includes location information and/or integrity information of the terminal device (101), the integrity information includes the error information and/or alarm information, and the alarm information includes a determining result obtained by comparing the first positioning result with a preset determining condition.

### CROSS-REFERENCE TO RELATED APPLICATIONS

This application is a continuation of U.S. patent application Ser. No. 17/953,774, filed on Sep. 27, 2022, which is a continuation of International Application No. PCT/CN2020/082225, filed on Mar. 30, 2020. All of the afore-mentioned patent applications are hereby incorporated by reference in their entireties.

### TECHNICAL FIELD

This application relates to the field of positioning technologies, and in particular, to a method for controlling positioning integrity and an apparatus.

### BACKGROUND TECHNOLOGY

Currently, the 3rd generation partnership project (3rd generation partnership project, 3GPP) technical report (technical report, TR) 22.872 defines a preliminary concept of positioning integrity. In other words, integrity is a measure of the trust, and the trust refers to a degree of trust in accuracy of information provided by a navigation system. The integrity further includes an ability to provide timely and valid warnings to a terminal device when a positioning system does not fulfil a condition for an intended operation (for example, when a positioning error is large).

Ensuring the integrity of the positioning system is an important research point in R17. In a conventional technology, reporting of a positioning measurement error is only preliminarily researched, and currently there is no feasible solution for evaluating the positioning integrity of the positioning system. Consequently, the positioning integrity of the positioning system cannot be ensured, and positioning accuracy and reliability are poor.

### SUMMARY

This application provides a method for controlling positioning integrity and an apparatus. A hierarchical alarm mechanism can be used for positioning errors of different systems, and the positioning integrity can be controlled in real time, to ensure high reliability of a positioning system.

According to a first aspect, a method for controlling positioning integrity is provided, including: A location management device receives a first message sent by a terminal device, where the first message includes a first parameter set, the first parameter set includes measurement information and/or error information that are/is related to location information of the terminal device, the error information is related to the positioning integrity, and the error information includes at least one or more of the following information: a protection level, an error source, an error value, a positioning error PE, an integrity level, a threat model, a threat occurrence rate, and a failure mode; and the location management device obtains a first positioning result based on the first parameter set and/or positioning assistance data, where the first positioning result includes location information and/or integrity information of the terminal device, the integrity information includes the error information and/or alarm information, the alarm information includes a determining result obtained by comparing the first positioning result with a preset determining condition, and the determining result includes at least one or more of the following information: information about whether an alarm is required, an alarm level corresponding to the first positioning result, and the error information.

At present, the 3GPP standard only discusses a measurement error in a positioning system, and does not consider other error sources that affect reliability of the positioning system. In addition, the existing positioning system lacks an alarm mechanism related to a system positioning error, and cannot ensure integrity (integrity) of the positioning system. In this application, for an LMF-based positioning solution, the method for controlling the positioning integrity is designed, so that the positioning system does not need to send an alarm until the system is unavailable or an integrity risk occurs, but sends a warning when the integrity risk is about to occur, to ensure positioning accuracy in real time and high reliability of the positioning system.

In a possible implementation, the determining result includes: if the first positioning result meets the preset determining condition, the determining result includes at least one or more of the following information: the alarm information, the alarm level corresponding to the first positioning result, and the error information; and if the first positioning result does not meet the preset determining condition, the determining result selectively includes no-alarm information; or if the first positioning result does not meet the preset determining condition, the determining result includes at least one or more of the following information: the alarm information, the alarm level corresponding to the first positioning result, and the error information; and if the first positioning result meets the preset determining condition, the determining result selectively includes no-alarm information.

According to the foregoing technical solution, the positioning system can clearly indicate the error information, for example, the error source and the error value, in the corresponding alarm information, so that the positioning system can perform corresponding positioning error correction based on the error information, thereby effectively ensuring the integrity of the positioning system and high reliability of the positioning system.

In a possible implementation, the method for controlling the positioning integrity further includes: the preset determining condition includes one or more sub-determining conditions, and the alarm level includes one or more sub-alarm levels; and one sub-alarm level corresponds to the one or more sub-determining conditions; or the one or more sub-alarm levels correspond to one sub-determining condition.

According to the foregoing technical solution, the positioning system can use a hierarchical alarm mechanism for positioning errors of different systems. This helps the positioning system determine whether a positioning result is valid, and may enable the positioning system to make a corresponding adjustment according to operating statuses corresponding to different alarm levels. This operation can effectively ensure the integrity of the positioning system.

In a possible implementation, the method for controlling the positioning integrity further includes: The location management device sends the first positioning result to an access and mobility management device.

According to the foregoing technical solution, the location management device may send, based on different manners of initiating a positioning request, the first positioning result including the error information and/or the alarm information to the access and mobility management device, or the access and mobility management device forwards the first positioning result to another device or function that initiates the positioning request.

In a possible implementation, the location management device performs positioning error correction based on the first positioning result, and obtains a second positioning result obtained after the positioning error correction, where the second positioning result includes location information and/or integrity information, of the terminal device, obtained after the positioning error correction.

According to the foregoing technical solution, the location management device may perform the positioning error correction on the first positioning result based on the error information reported by the terminal device, for example, the error source and the error value, to obtain the second positioning result obtained after the positioning error correction, to ensure positioning accuracy in real time and high reliability of the positioning system.

In a possible implementation, the location management device sends the second positioning result to the access and mobility management device.

According to the foregoing technical solution, the location management device may send, based on different manners of initiating a positioning request, the second positioning result including the error information and/or the alarm information to the access and mobility management device, or the access and mobility management device forwards the second positioning result to another device or function that initiates the positioning request.

In a possible implementation, before the location management device receives the first message sent by the terminal device, the method for controlling the positioning integrity further includes: The location management device receives a positioning request sent by the access and mobility management device, where the positioning request includes first indication information related to the positioning integrity, and the first indication information indicates one or more of the following information: an alert limit, an integrity risk, a time to alert, an error source, a threat model, a threat occurrence rate, a failure mode, an error value, and an integrity level.

The access and mobility management device may receive a location service request related to the terminal device from a third-party device or function such as the terminal device or a 5GC LCS entity. Alternatively, the access and mobility management device may initiate some positioning requests on behalf of a specific terminal device. According to the foregoing solution, the access and mobility management device may forward the positioning request (the location service request) to the location management device, to start a positioning procedure.

In a possible implementation, before the location management device receives the first message sent by the terminal device, the method for controlling the positioning integrity further includes: The location management device receives a second message sent by a next-generation radio access network device, where the second message includes the positioning assistance data related to the location information of the terminal device.

According to the foregoing solution, the location management device may obtain assistance data necessary for locating the terminal device. Then, the terminal device is located based on the necessary assistance data.

According to a second aspect, a method for controlling positioning integrity is provided, including: A terminal device obtains a second parameter set, where the second parameter set includes measurement information and/or error information that are/is related to location information of the terminal device, the error information is related to the positioning integrity, and the error information includes at least one or more of the following information: a protection level, an error source, an error value, a positioning error PE, an integrity level, a threat model, a threat occurrence rate, and a failure mode; and
the terminal device obtains a third positioning result based on the second parameter set and/or positioning assistance data, where the third positioning result includes location information and/or integrity information of the terminal device, the integrity information includes the error information and/or alarm information, the alarm information includes a determining result obtained by comparing the third positioning result with a preset determining condition, and the determining result includes at least one or more of the following information: information about whether an alarm is required, an alarm level corresponding to the third positioning result, and the error information.

At present, the 3GPP standard only discusses a measurement error in a positioning system, and does not consider other error sources that affect reliability of the positioning system. In addition, the existing positioning system lacks an alarm mechanism related to a system positioning error, and cannot ensure integrity (integrity) of the positioning system. In this application, for a UE-based positioning solution, the method for controlling the positioning integrity is designed, so that the positioning system does not need to send an alarm until the system is unavailable or an integrity risk occurs, but sends a warning when the integrity risk is about to occur, to ensure positioning accuracy in real time and high reliability of the positioning system. In a possible implementation, the determining result includes: if the third positioning

result meets the preset determining condition, the determining result includes at least one or more of the following information: the alarm information, an alarm level corresponding to the third positioning result, and the error information; and if the third positioning result does not meet the preset determining condition, the determining result selectively includes no-alarm information; or if the third positioning result does not meet the preset determining condition, the determining result includes at least one or more of the following information: the alarm information, an alarm level corresponding to the third positioning result, and the error information; and if the third positioning result meets the preset determining condition, the determining result selectively includes no-alarm information.

According to the foregoing technical solution, the positioning system can clearly indicate the error information, for example, the error source and the error value, in the corresponding alarm information, so that the positioning system can perform corresponding positioning error correction based on the error information, thereby effectively ensuring the integrity of the positioning system and high reliability of the positioning system.

In a possible implementation, the method for controlling the positioning integrity further includes: the preset determining condition includes one or more sub-determining conditions, and the alarm level includes one or more sub-alarm levels; and one sub-alarm level corresponds to the one or more sub-determining conditions; or the one or more sub-alarm levels correspond to one sub-determining condition.

According to the foregoing technical solution, the positioning system can use a hierarchical alarm mechanism for positioning errors of different systems. This helps the positioning system determine whether a positioning result is valid, and may enable the positioning system to make a corresponding adjustment according to operating statuses corresponding to different alarm levels. This operation can effectively ensure the integrity of the positioning system.

In a possible implementation, the method for controlling the positioning integrity further includes: The terminal device sends the third positioning result to a location management device.

According to the foregoing technical solution, the terminal device may send the third positioning result including the error information and/or the alarm information to the location management device. This helps the location management device perform subsequent positioning processing. Alternatively, the terminal device may send, based on different manners of initiating a positioning request, the third positioning result including the error information and/or the alarm information to the location management device, and the location management device finally forwards the third positioning result to another device or function that initiates the positioning request.

In a possible implementation, the method for controlling the positioning integrity further includes: The terminal device performs positioning error correction based on the third positioning result, and obtains a fourth positioning result obtained after the positioning error correction, where the fourth positioning result includes location information and/or integrity information, of the terminal device, obtained after the positioning error correction.

According to the foregoing technical solution, the terminal device may perform the positioning error correction on the third positioning result based on the obtained error information, for example, the error source and the error value, to obtain the fourth positioning result obtained after the positioning error correction, to ensure positioning accuracy in real time and ensure high reliability of the positioning system.

In a possible implementation, the terminal device sends the fourth positioning result to the location management device.

According to the foregoing technical solution, the terminal device may send the third positioning result, obtained after the positioning error correction, including the error information and/or the alarm information to the location management device. This helps the location management device perform subsequent positioning processing. Alternatively, the terminal device may send, based on different manners of initiating a positioning request, the fourth positioning result obtained after the positioning error correction to the location management device, and the location management device finally forwards the fourth positioning result to another device or function that initiates the positioning request.

In a possible implementation, the method for controlling the positioning integrity further includes: The terminal device sends a positioning request to an access and mobility management device, where the positioning request includes first indication information related to the positioning integrity, and the first indication information indicates one or more of the following information: an alert limit, an integrity risk, a time to alert, an error source, a threat model, a threat occurrence rate, a failure mode, an error value, and an integrity level.

According to the foregoing solution, the terminal device may forward the positioning request (or referred to as a location service request) to the location management device by using the access and mobility management device, to initiate a positioning procedure.

In a possible implementation, before the terminal device obtains the second parameter set, the method for controlling the positioning integrity further includes: The terminal device receives a third message sent by the location management device, where the third message includes the positioning assistance data related to the location information of the terminal device, and the positioning assistance data is received by the location management device from a next-generation radio access network device.

According to the foregoing solution, the terminal device may obtain, from the location management device, assistance data necessary for locating the terminal device. Then, the terminal device is located based on the necessary assistance data.

In a possible implementation, that a terminal device obtains a second parameter set includes: The terminal device obtains the second parameter set through measurement, or from the next-generation radio access network device, or from a network device that participates in positioning and that includes a location management component.

According to the foregoing solution, the terminal device may obtain the second parameter set necessary for locating the terminal device. The second parameter set may be obtained through measurement performed by the terminal device, measurement performed by the network device participating in positioning, and/or measurement performed by the network device that participates in positioning and that includes the location management component.

According to a third aspect, a location management apparatus is provided, configured to perform the method according to any one of the first aspect or the possible implementations of the first aspect. The location management apparatus may be the location management device according to any one of the first aspect or the possible implementations of the first aspect, or a module applied to the location management device, for example, a chip or a chip system. The location management apparatus includes a module, unit, or means (means) corresponding to the method performed by the location management apparatus according to any one of the first aspect or the possible implementations of the first aspect. The module, unit, or means may be implemented by hardware or software, or may be implemented by hardware executing corresponding software. The hardware or software includes one or more modules or units corresponding to the function performed by the location management device according to any one of the first aspect or the possible implementations of the first aspect.

The location management apparatus includes: a transceiver unit, configured to receive a first message sent by a terminal device, where the first message includes a first parameter set, the first parameter set includes measurement information and/or error information that are/is related to location information of the terminal device, the error information is related to positioning integrity, and the error information includes at least one or more of the following information: a protection level, an error source, an error value, a positioning error PE, an integrity level, a threat model, a threat occurrence rate, and a failure mode; and
a processing unit, configured to obtain a first positioning result based on the first parameter set and/or positioning assistance data, where the first positioning result includes location information and/or integrity information of the terminal device, the integrity information includes the error information and/or alarm information, the alarm information includes a determining result obtained by comparing the first positioning result with a preset determining condition, and the determining result includes at least one or more of the following information: information about whether an alarm is required, an alarm level corresponding to the first positioning result, and the error information.

In a possible implementation, the determining result includes: if the first positioning result meets the preset determining condition, the determining result includes at least one or more of the following information: the alarm information, the alarm level corresponding to the first positioning result, and the error information; and if the first positioning result does not meet the preset determining condition, the determining result selectively includes no-alarm information; or if the first positioning result does not meet the preset determining condition, the determining result includes at least one or more of the following information: the alarm information, the alarm level corresponding to the first positioning result, and the error information; and if the first positioning result meets the preset determining condition, the determining result selectively includes no-alarm information.

In a possible implementation, the preset determining condition includes one or more sub-determining conditions, and the alarm level includes one or more sub-alarm levels; and one sub-alarm level corresponds to the one or more sub-determining conditions; or the one or more sub-alarm levels correspond to one sub-determining condition.

In a possible implementation, the transceiver unit is further configured to send the first positioning result to an access and mobility management device.

In a possible implementation, the processing unit is further configured to perform positioning error correction based on the first positioning result, and obtain a second positioning result obtained after the positioning error correction, where the second positioning result includes location information and/or integrity information, of the terminal device, obtained after the positioning error correction.

In a possible implementation, the transceiver unit is further configured to send the second positioning result to the access and mobility management device.

In a possible implementation, before receiving the first message sent by the terminal device, the transceiver unit is further configured to receive a positioning request sent by the access and mobility management device, where the positioning request includes first indication information related to the positioning integrity, and the first indication information indicates one or more of the following information: an alert limit, an integrity risk, a time to alert, an error source, a threat model, a threat occurrence rate, a failure mode, an error value, and an integrity level.

In a possible implementation, before receiving the first message sent by the terminal device, the transceiver unit is further configured to receive a second message sent by a next-generation radio access network device, where the second message includes the positioning assistance data related to the location information of the terminal device.

For beneficial effects of any one of the third aspect and the possible implementations of the third aspect, refer to the corresponding beneficial effects of any one of the first aspect and the possible implementations of the first aspect. Details are not described herein again.

According to a fourth aspect, a terminal apparatus is provided, configured to perform the method according to any one of the second aspect or the possible implementations of the second aspect. The terminal apparatus may be the terminal device according to any one of the second aspect or the possible implementations of the second aspect, or a module applied to the terminal device, for example, a chip or a chip system. The terminal apparatus includes a module, unit, or means (means) corresponding to the method performed by the terminal apparatus according to any one of the second aspect or the possible implementations of the second aspect. The module, unit, or means may be implemented by hardware or software, or may be implemented by hardware executing corresponding software. The hardware or software includes one or more modules or units corresponding to the function performed by the terminal device according to any one of the second aspect or the possible implementations of the second aspect.

The provided terminal apparatus includes: a processing unit, configured to obtain a second parameter set, where the second parameter set includes measurement information and/or error information that are/is related to location information of the terminal device, the error information is related to positioning integrity, and the error information includes at least one or more of the following information: a protection level, an error source, an error value, a positioning error PE, an integrity level, a threat model, a threat occurrence rate, and a failure mode; where the processing unit is further configured to obtain a third positioning result based on the second parameter set and/or positioning assistance data, where the third positioning result includes location information and/or integrity information of the terminal device, the integrity information includes the error information and/or alarm information, the alarm information includes a determining result obtained by comparing the third positioning result with a preset determining condition, and the determining result includes at least one or more of the following information: information about whether an alarm is required, an alarm level corresponding to the third positioning result, and the error information.

In a possible implementation, the determining result includes: if the third positioning result meets the preset determining condition, the determining result includes at least one or more of the following information: the alarm information, an alarm level corresponding to the third positioning result, and the error information; and if the third positioning result does not meet the preset determining condition, the determining result selectively includes no-alarm information; or if the third positioning result does not meet the preset determining condition, the determining result includes at least one or more of the following information: the alarm information, an alarm level corresponding to the third positioning result, and the error information; and if the third positioning result meets the preset determining condition, the determining result selectively includes no-alarm information.

In a possible implementation, the preset determining condition includes one or more sub-determining conditions, and the alarm level includes one or more sub-alarm levels; and one sub-alarm level corresponds to the one or more sub-determining conditions; or the one or more sub-alarm levels correspond to one sub-determining condition.

In a possible implementation, the terminal apparatus further includes a transceiver unit, and the transceiver unit is configured to send the third positioning result to the location management device.

In a possible implementation, the processing unit is further configured to perform positioning error correction based on the third positioning result, and obtain a fourth positioning result obtained after the positioning error correction, where the fourth positioning result includes location information and/or integrity information, of the terminal device, obtained after the positioning error correction.

In a possible implementation, the transceiver unit is further configured to send the fourth positioning result to the location management device.

In a possible implementation, before obtaining the second parameter set, the transceiver unit is further configured to send a positioning request to an access and mobility management device, where the positioning request includes first indication information related to the positioning integrity, and the first indication information indicates one or more of the following information: an alert limit, an integrity risk, a time to alert, an error source, a threat model, a threat occurrence rate, a failure mode, an error value, and an integrity level.

In a possible implementation, before obtaining the second parameter set, the transceiver unit is further configured to receive a third message sent by the location management device, where the third message includes the positioning assistance data related to the location information of the terminal device, and the positioning assistance data is received by the location management device from a next-generation radio access network device.

In a possible implementation, the obtaining the second parameter set includes: The terminal apparatus obtains the second parameter set through measurement, or from the next-generation radio access network device, or from a network device that participates in positioning and that includes a location management component.

For beneficial effects of any one of the fourth aspect and the possible implementations of the fourth aspect, refer to the corresponding beneficial effects of any one of the second aspect and the possible implementations of the second aspect. Details are not described herein again.

According to a fifth aspect, a location management apparatus is provided, including: a processor, configured to execute a program stored in a memory, where when the program is executed, the location management apparatus is enabled to perform the method according to any one of the first aspect or the possible implementations of the first aspect.

In a possible implementation, the memory is located outside the location management apparatus.

According to a sixth aspect, a terminal apparatus is provided, including: a processor, configured to execute a program stored in a memory, where when the program is executed, the terminal apparatus is enabled to perform the method according to any one of the second aspect or the possible implementations of the second aspect.

In a possible implementation, the memory is located outside the terminal apparatus.

According to a seventh aspect, a location management apparatus is provided, including: an input/output interface, configured to receive a first message sent by a terminal device, where the first message includes a first parameter set, the first parameter set includes measurement information and/or error information that are/is related to location information of the terminal device, the error information is related to positioning integrity, and the error information includes at least one or more of the following information: a protection level, an error source, an error value, a positioning error PE, an integrity level, a threat model, a threat occurrence rate, and a failure mode; and a logic circuit, configured to obtain a first positioning result based on the first parameter set and/or positioning assistance data, where the first positioning result includes location information and/or integrity information of the terminal device, the integrity information includes the error information and/or alarm information, the alarm information includes a determining result obtained by comparing the first positioning result with a preset determining condition, and the determining result includes at least one or more of the following information: information about whether an alarm is required, an alarm level corresponding to the first positioning result, and the error information.

According to an eighth aspect, a terminal apparatus is provided, including: a logic circuit, configured to obtain a second parameter set, where the second parameter set includes measurement information and/or error information that are/is related to location information of the terminal device, the error information is related to positioning integrity, and the error information includes at least one or more of the following information: a protection level, an error source, an error value, a positioning error PE, an integrity level, a threat model, a threat occurrence rate, and a failure mode; where
the logic circuit is further configured to obtain a third positioning result based on the second parameter set and/or positioning assistance data, where the third positioning result includes location information and/or integrity information of the terminal device, the integrity information includes the error information and/or alarm information, the alarm information includes a determining result obtained by comparing the third positioning result with a preset determining condition, and the determining result includes at least one or more of the following information: information about whether an alarm is required, an alarm level corresponding to the third positioning result, and the error information; and
the terminal device further includes an input/output interface, configured to perform an input/output function.

According to a ninth aspect, a computer-readable storage medium is provided. The computer-readable storage medium stores a computer program, and when the computer program is executed by a computer, the computer program is used to implement a function performed by the location management device according to any one of the first aspect or the possible implementations of the first aspect.

According to a tenth aspect, a computer-readable storage medium is provided. The computer-readable storage medium stores a computer program, and when the computer program is executed by a computer, the computer program is used to implement a function performed by the terminal device according to any one of the second aspect or the possible implementations of the second aspect.

According to an eleventh aspect, a computer program product is provided. The computer program product includes a computer program. When the computer program product is run on a computer, the computer program product is configured to implement a function performed by the location management device according to any one of the first aspect or the possible implementations of the first aspect.

According to a twelfth aspect, a computer program product is provided. The computer program product includes a computer program. When the computer program product is run on a computer, the computer program product is configured to implement a function performed by the terminal device according to any one of the second aspect or the possible implementations of the second aspect.

According to a thirteenth aspect, a chip system is provided, including at least one processor and an interface, where the at least one processor is coupled to a memory through the interface, and when executing a computer program or a computer-executable instruction in the memory, the at least one processor is configured to implement a function performed by the location management device according to any one of the first aspect or the possible implementations of the first aspect.

According to a fourteenth aspect, a chip system is provided, including at least one processor and an interface, where the at least one processor is coupled to a memory through the interface, and when executing a computer program or a computer-executable instruction in the memory, the at least one processor is configured to implement a function performed by the terminal device according to any one of the second aspect or the possible implementations of the second aspect.

For beneficial effects of the apparatus embodiments in the fifth aspect to the fourteenth aspect, refer to the beneficial effects of the corresponding method according to any one of the first aspect and the possible implementations of the first aspect or any one of the second aspect and the possible implementations of the second aspect. Details are not described herein again.

### BRIEF DESCRIPTION OF DRAWINGS

FIG. 1 is a schematic diagram 1 of a positioning system architecture according to this application;

FIG. 2 is a schematic diagram 2 of a positioning system architecture according to this application;

FIG. 3 is a schematic diagram 3 of a positioning system architecture according to this application;

FIG. 4 is a schematic diagram 4 of a positioning system architecture according to this application;

FIG. 5 is a Stanford diagram of a civil aviation system;

FIG. 6 shows operating statuses related to integrity in a positioning system according to this application;

FIG. 7 is a schematic diagram of a hierarchical alarm mechanism according to an embodiment of this application;

FIG. 8A and FIG. 8B are a schematic flowchart of a method 800 for controlling positioning integrity according to an embodiment of this application;

FIG. 9A and FIG. 9B are a schematic flowchart of another method 900 for controlling positioning integrity according to an embodiment of this application;

FIG. 10 is a schematic block diagram of a location management apparatus 1000 according to an embodiment of this application;

FIG. 11 is a schematic block diagram of a location management apparatus 1100 according to an embodiment of this application;

FIG. 12 is a schematic block diagram of a terminal apparatus 1200 according to an embodiment of this application; and

FIG. 13 is a schematic block diagram of a terminal apparatus 1300 according to an embodiment of this application.

### DESCRIPTION OF EMBODIMENTS

The following details technical solutions of this application with reference to the accompanying drawings.

FIG. 1 shows a possible positioning system architecture applicable to an embodiment of this application. The positioning system may include a terminal device 101, a network device 102, and a location management device 103. The location management device 103 is configured to perform positioning calculation on the terminal device 101 based on a measurement result of another network element (for example, the terminal device 101 or the network device 102), or the terminal device 101 may perform positioning calculation on the terminal device 101 based on a measurement result of the terminal device 101 or another network element (for example, the network device 102). The positioning system may further include a measurement network element (or a location measurement network element) 104. The measurement network element may also be referred to as a measurement node. The location management device 103 is connected to the measurement network element 104 through an SLM interface or an NG interface. When the measurement network element 104 is a network device, the location management device 103 is connected to the measurement network element 104 through the NG interface. An interface between the location management device 103 and the measurement network element 104 may alternatively be an Xn interface. The network device 102 may be a serving base station of the terminal device 101. The network device 102 provides an access service for the terminal device 101. After accessing the network device 102, the terminal device 101 may communicate with a network side by using the network device 102. The measurement network element 104 may be a network device, for example, a device configured to measure positioning information such as a next-generation base station (next-generation NodeB, gNB) or a positioning measurement unit (location measurement unit, LMU) in a 5th generation (5th generation, 5G) communication system, or the terminal device 101. The positioning information may be obtained by measuring a reference signal sent by the terminal device or by measuring, by the terminal device, a reference signal sent by the network device. The network device or the LMU may measure a reference signal sent by the terminal device 101, to obtain a measurement result for locating the terminal device. The terminal device may alternatively measure a reference signal sent by the network device 102, to obtain a measurement result for locating the terminal device. An example in which the measurement network element 104 is a network device (for example, the serving base station or a neighboring cell base station) and the location management device 103 is connected to the measurement network element 104 through the NG interface is used below for description.

In a possible implementation, the terminal device 101 communicates with the network device 102 through a cellular link (a Uu link), and the network device 102 communicates with the location management device 103 through an NG-C interface.

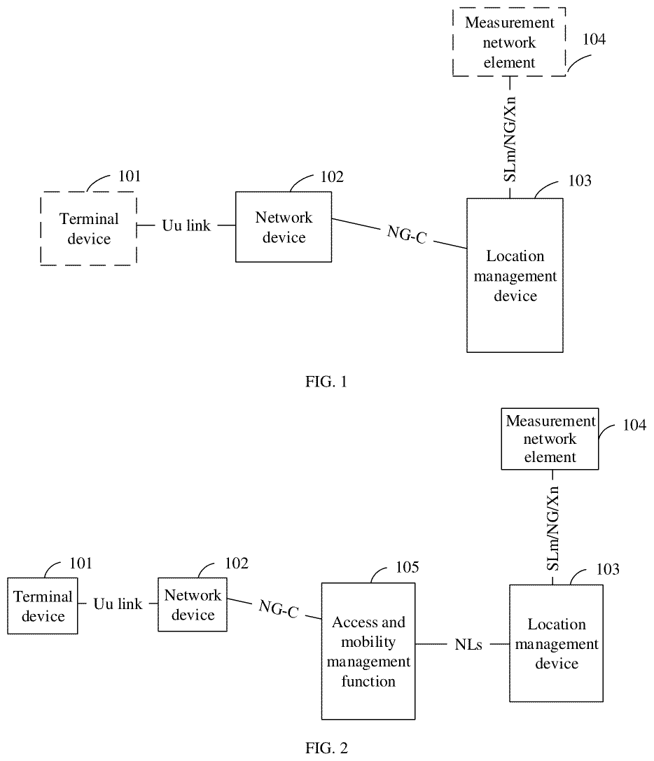

Optionally, based on the positioning system architecture shown in FIG. 1, as shown in FIG. 2, the positioning system applied to this application may further include an access and mobility management function (access and mobility management function, AMF) 105. The access and mobility management function 105 is access control and mobility management that a control plane network element provided by an operator is responsible for accessing an operator network by the terminal device 101. The network device 102 communicates with the access and mobility management device 105 through the NG-C interface, and the access and mobility management function 105 communicates with the location management device 103 through an NLs interface. The location management device 103 may interact with the network device 102 by using the access and mobility management function 105.

Optionally, the location management device in this application may be a location management function (location management function, LMF) or a location management component (location management component, LMC), or may be a local location management function (local location management function, LLMF) in the network device. In the following embodiments, an example in which the location management device is the location management function LMF is used for description. This is not limited in this application.

The method for controlling the positioning integrity provided in this application may be applied to various communication systems, for example, a long term evolution (long term evolution, LTE) system, an LTE frequency division duplex (frequency division duplex, FDD) system, an LTE time division duplex (time division duplex, TDD) system, a 5th generation (5th generation, 5G) communication system, for example, a new radio (new radio, NR) system, or various future communication systems, for example, a 6th generation (6th generation, 6G) communication system, a public land mobile network (public land mobile network, PLMN), a device-to-device (device-to-device, D2D) communication system, a machine-to-machine (machine-to-machine, M2M) communication system, an internet of things (Internet of Things, IoT) communication system, or another communication system.

The 5G communication system is used as an example. A network element or an entity corresponding to the network device in FIG. 1 or FIG. 2 may be a next-generation radio access network (next-generation radio access network, NG-RAN) device in the 5G communication system. Optionally, in this application, a “next-generation radio access network device” and a “network device” may be considered equivalent. This is not specifically limited in this application.

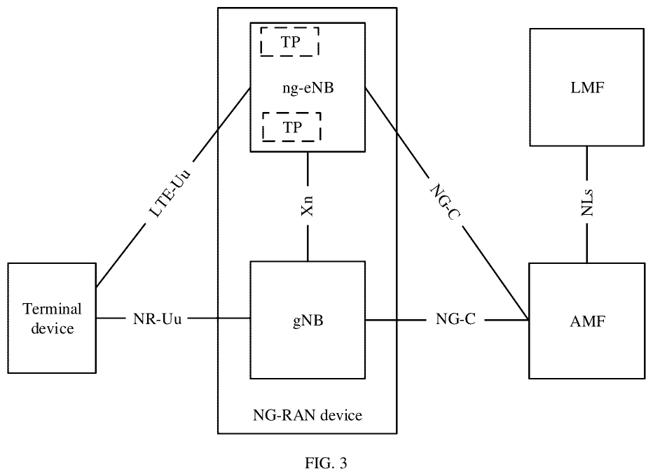

For example, FIG. 3 is an architectural diagram of another positioning system applied to an embodiment of this application. The positioning system mainly performs positioning with the assistance of a 5G core network (5G core, 5GC), an LMF, a next-generation radio access network, and a terminal device. As shown in FIG. 3, in the positioning system, the terminal device is connected to the next-generation radio access network NG-RAN through an LTE-Uu interface and/or an NR-Uu interface respectively by using a next-generation evolved NodeB (next-generation evolved NodeB, ng-eNB) and a next-generation NodeB (generation NodeB, gNB). The next-generation radio access network NG-RAN is connected to the 5G core network (5G core, 5GC) through an NG-C interface by using an access and mobility management function AMF. The next-generation radio access network NG-RAN includes one or more next-generation LTE base stations (Next-generation eNodeB, ng-eNB) (one ng-eNB is used as an example in FIG. 3). The NG-RAN may also include one or more next-generation base stations (next-generation NodeB, gNB) (one gNB is used as an example in FIG. 3). The NG-RAN may further include one or more ng-eNBs and one or more gNBs. The ng-eNB is an LTE base station that accesses the 5G core network, and the gNB is a 5G base station that accesses the 5G core network. The 5G core network includes the access and mobility management function AMF and the location management function LMF. The AMF is configured to implement access control and mobility management, and the LMF is configured to implement a function such as positioning or positioning assistance. The AMF is connected to the LMF through an NLs interface. In the positioning architecture based on the 5G core network, functions of the functional entities are mainly as follows:
(1) The LMF supports different types of location services related to the terminal device, including locating the terminal device, transmitting assistance data to the terminal device, and the like. A control plane and a user plane of the LMF are respectively an enhanced serving mobile location center (enhanced serving mobile location center, E-SMLC) and a secure user plane location (secure user plane location, SUPL) location platform (SUPL location platform, SLP). The LMF may exchange the following information with the ng-eNB/gNB and the terminal device.
a. Exchange information with the ng-eNB/gNB by using an NR positioning protocol annex (NR positioning protocol annex, NRPPa) message, for example, obtaining positioning reference signal (positioning reference signal, PRS) configuration information, sounding reference signal (sounding reference signal, SRS) configuration information, cell timing, and cell location information.
b. Transfer terminal device capability information, auxiliary information, measurement information, and the like with the terminal device by using an LTE positioning protocol (LTE positioning protocol, LPP) message.
(2) The AMF may receive a location service request related to the terminal device from a third-party device or function such as a 5G core network (5G core network, 5GC) location service (location services, LCS) entity. Alternatively, the AMF may initiate some location services on behalf of a specific terminal device, and forward the location service request to the LMF. After obtaining location information returned by the terminal device, the AMF returns related location information to the third-party device or function such as the 5GC LCS entity.
(3) The terminal device may measure a downlink signal from the NG-RAN device and another source to support positioning.
(4) The gNB/ng-eNB may provide measurement information for the target terminal device, and transfer the information to the LMF.

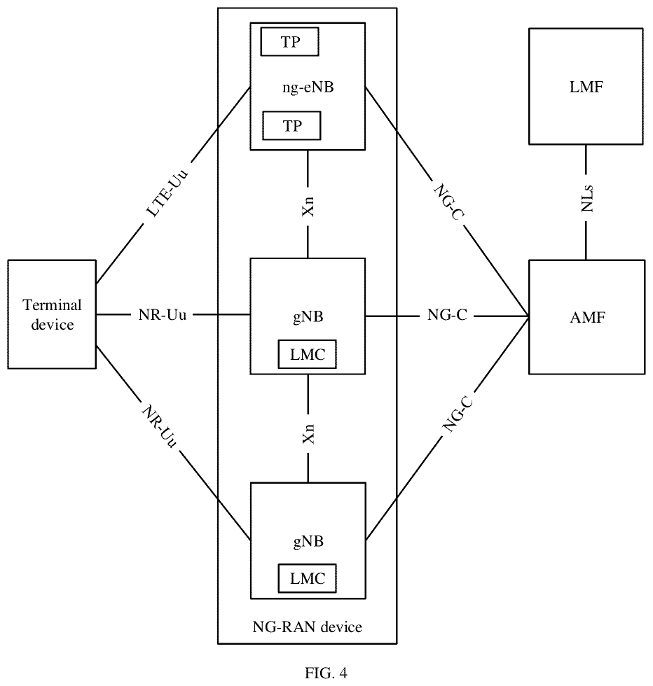

For example, FIG. 4 is an architectural diagram of still another positioning system applied to an embodiment of this application. A difference between the positioning system architectures in FIG. 4 and FIG. 3 lies in that the apparatus or the component (for example, the LMF) that performs the location management function in FIG. 3 is deployed in a core network, and an apparatus or a component (for example, an LMC network element) that performs a location management function in FIG. 4 may be deployed in an NG-RAN device. As shown in FIG. 4, a gNB includes an LMC network element. The LMC network element is a functional component of the LMF and may be integrated into the gNB on the NG-RAN device.

It should be understood that a device or a function node in the positioning system shown in FIG. 1 to FIG. 4 is merely described as an example, and does not constitute a limitation on this application. In practice, the positioning system in FIG. 1 to FIG. 4 may further include another network element, device, or function node that has an interaction relationship with the device or function node shown in the figure. This is not specifically limited herein.

The following explains and describes some nouns or terms used in this application, and the nouns or terms are also used as a part of the present invention.

### 1. Terminal Device

The terminal device may be referred to as a terminal for short, and is a device having a wireless transceiver function. The terminal device may be deployed on land, where the deployment includes indoor or outdoor, or handheld or vehicle-mounted deployment, may be deployed on water (for example, on a ship), or may be deployed in air (for example, on aircraft, a balloon, or a satellite). The terminal device may be a mobile phone (mobile phone), a tablet computer (pad), a computer having a wireless transceiver function, a virtual reality (virtual reality, VR) terminal device, an augmented reality (augmented reality, AR) terminal device, a wireless terminal device in industrial control (industrial control), a wireless terminal device in self driving (self driving), a wireless terminal device in telemedicine (remote medical), a wireless terminal device in a smart grid (smart grid), a wireless terminal device in transportation safety (transportation safety), a wireless terminal device in a smart city (smart city), or a wireless terminal device in a smart home (smart home), or may alternatively be user equipment (user equipment, UE) or the like. The terminal device may alternatively be a cellular phone, a cordless phone, a session initiation protocol (session initiation protocol, SIP) phone, a wireless local loop (wireless local loop, WLL) station, a personal digital assistant (personal digital assistant, PDA), a handheld device with a wireless communication function, a computing device or another processing device connected to a wireless modem, a vehicle-mounted device, a wearable device, a terminal device in a 5th generation (5th generation, 5G) communication system, a terminal device in a future evolved 6G communication system, or the like. The terminal device sometimes may also be referred to as a terminal, an access terminal device, a vehicle-mounted terminal device, an industrial control terminal device, a UE unit, a UE station, a mobile station, a mobile console, a remote station, a remote terminal device, a mobile device, a UE terminal device, a terminal device, a wireless communication device, a UE agent, a UE apparatus, or the like. The terminal device may be fixed or mobile. This is not limited in this application.

In this application, an apparatus configured to implement a function of a terminal device may be a terminal device, or may be an apparatus, for example, a chip system, that can support the terminal device to implement the function. The apparatus may be mounted in the terminal device. In this application, the chip system may include a chip, or may include a chip and another discrete component. In the technical solution provided in this embodiment of this application, an example in which the apparatus for implementing the function of the terminal device is a terminal device and the terminal device is UE is used to describe the technical solution provided in this application.

The terminal device may further include a device that provides a user with voice and/or data connectivity, for example, may include a handheld device having a wireless connection function, or a processing device connected to a wireless modem. The terminal device may communicate with a core network by using a radio access network (radio access network, RAN), and exchange a voice and/or data with the RAN. The terminal device may include user equipment (user equipment, UE), a wireless terminal device, a mobile terminal device, a device-to-device (device-to-device, D2D) communication terminal device, a V2X terminal device, a machine-to-machine/machine-type communication (machine-to-machine/machine-type communications, M2M/MTC) terminal device, an internet of things (internet of things, IoT) terminal device, a subscriber unit (subscriber unit), a subscriber station (subscriber station), a mobile station (mobile station), a remote station (remote station), an access point (access point, AP), a remote terminal (remote terminal), an access terminal (access terminal), a user terminal (user terminal), a user agent (user agent), a user device (user device), or the like. For example, the terminal device may include a mobile phone (or referred to as a “cellular” phone), a computer having a mobile terminal device, or a portable, pocket-sized, handheld, or computer built-in mobile apparatus, for example, a personal communications service (personal communications service, PCS) phone. The terminal device may alternatively include a limited device, for example, a device with low power consumption, a device with a limited storage capability, or a device with a limited computing capability, for example, an information sensing device such as a barcode, radio frequency identification (radio frequency identification, RFID), a sensor, a global positioning system (global positioning system, GPS), or a laser scanner, or a terminal device in a new evolved public land mobile network (Public Land Mobile Network, PLMN). This is not limited in this embodiment of this application.

For example, the terminal device may include a radio resource control (radio resource control, RRC) signaling exchange module, a media access control (media access control, MAC) signaling exchange module, and a physical (physical, PHY) signaling exchange module. The RRC signaling exchange module may be a module used by the network device and the terminal device to send and receive RRC signaling. The MAC signaling exchange module may be a module used by the network device and the terminal device to send and receive MAC control element (control element, CE) signaling. PHY signaling and data may be a module used by the network device and the terminal device to send and receive uplink control signaling or downlink control signaling, and uplink and downlink data or downlink data.

### 2. Network Device

The network device may be a base station. The network device may also be referred to as a radio access network (radio access network, RAN) device, and is a device that provides a wireless communication function for the terminal device. The network device, for example, includes but is not limited to: a next-generation base station (next-generation NodeB, gNB) in 5G, an evolved NodeB (evolved NodeB, eNB), a baseband unit (baseband unit, BBU), a transmitting and receiving point (transmitting and receiving point, TRP), a transmitting point (transmitting point, TP), and a mobile switching center. The network device may further be a radio controller, a centralized unit (centralized unit, CU), and/or a distributed unit (distributed unit, DU) in a cloud radio access network (cloud radio access network, CRAN) scenario, or the network device may be a relay station, an access point, a vehicle-mounted device, a wearable device, a network device in a 5G network, a network device in a future evolved PLMN network, or the like. The terminal device may communicate with a plurality of network devices using different communication technologies. For example, the terminal device may communicate with a network device supporting a long term evolution (long term evolution, LTE) system, may communicate with a network device supporting 5G, or may communicate with a network device, in a dual connectivity, supporting LTE and supporting 5G. This is not limited in this application.

In embodiments of this application, an apparatus configured to implement a network device function may be a network device, or may be an apparatus, for example, a chip system, that can support the network device to implement the function. The apparatus may be installed in the network device. In the technical solution provided in this application, an example in which the apparatus for implementing the network device function is a network device and the network device is a base station is used to describe the technical solution provided in this application.

The network device includes, for example, an access network (access network, AN) device, for example, a base station (for example, an access point), and may be a device that is in an access network and that communicates with a wireless terminal device over an air interface through one or more cells. The base station may be configured to mutually convert a received over-the-air frame and an internet protocol (IP) packet, and serve as a router between the terminal device and a remaining part of the access network. The remaining part of the access network may include an IP network. A road side unit (road side unit, RSU) may be a fixed infrastructure entity that supports a vehicle to X (vehicle to X, V2X) application, and may exchange a message with another entity that supports the V2X application. The network device may further coordinate attribute management of the air interface. For example, the network device may include an evolved base station (NodeB, eNB, or e-NodeB, evolutional NodeB) in an LTE system or a long term evolution-advanced (long term evolution-advanced, LTE-A) system, may include a next-generation NodeB (next-generation NodeB, gNB) in a 5th generation mobile communication technology (the 5th generation, 5G) new radio (new radio, NR) system, or may include a centralized unit (centralized unit, CU) and a distributed unit (distributed unit, DU) in a cloud access network (cloud radio access network, Cloud RAN) system. This is not limited in this application.

For example, the network device may also include an RRC signaling exchange module, a MAC signaling exchange module, and a PHY signaling exchange module. In some deployments, the network device may include a centralized unit (centralized unit, CU) and a distributed unit (distributed unit, DU). The network device may further include an active antenna unit (active antenna unit, AAU). The CU implements some functions of the network device, and the DU implements some other functions of the network device. For example, the CU is responsible for processing a non-real-time protocol and service, and implements functions of a radio resource control (radio resource control, RRC) layer and a packet data convergence protocol (packet data convergence protocol, PDCP) layer. The DU is responsible for processing a physical layer protocol and a real-time service, and implements functions of a radio link control (radio link control, RLC) layer, a media access control (media access control, MAC) layer, and a physical (physical, PHY) layer. The AAU implements a part of processing functions of the physical layer, radio frequency processing, and a function related to an active antenna. Information at the RRC layer is eventually converted into information at the PHY layer, or is converted from information at the PHY layer. Therefore, in this architecture, higher layer signaling such as RRC layer signaling may also be considered as being sent by the DU or sent by the DU and the AAU. It may be understood that the network device may be a device including one or more of a CU node, a DU node, and an AAU node. In addition, the CU may be a network device in an access network (radio access network, RAN), or the CU may be a network device in a core network (core network, CN). This is not limited in this application.

### 3. Location Management Device

In conclusion, the location management device may locate the terminal device based on a positioning request of the AMF (positioning may also be referred to as positioning measurement, and is not distinguished in embodiments of this application). When locating the terminal device, the location management device may determine a positioning method for locating the terminal device and a network device for locating the terminal device. Optionally, the location management device in embodiments of this application may be a location management function (location management function, LMF) or a location management component (location management component, LMC) network element, or may be a local location management function (local location management function, LLMF) in the network device. In this application, only an example of using the LMF as the location management device is used to describe the positioning method provided in this application. A location management device that is in another or a next-generation communication system and that has a function similar to that of the LMF is also included in the protection scope of this application. This is not limited in this application.

For example, the LMF supports different types of location services related to the target terminal device, including locating the terminal device, transmitting assistance data to the terminal device, and the like. A control plane and a user plane of the LMF are respectively an enhanced serving mobile location center (enhanced serving mobile location center, E-SMLC) and a secure user plane location (secure user plane location, SUPL) location platform (SUPL location platform, SLP). The LMF may exchange the following information with the ng-eNB/gNB and the terminal device.
a. Exchange information with the ng-eNB/gNB by using an NR positioning protocol annex (NR positioning protocol annex, NRPPa) message, for example, obtaining positioning reference signal (positioning reference signal, PRS) configuration information, sounding reference signal (sounding reference signal, SRS) configuration information, cell timing, and cell location information.
b. Transfer terminal device capability information, auxiliary information, measurement information, and the like with the terminal device by using an LTE positioning protocol (LTE positioning protocol, LPP) message.

### 4. Positioning Request Type

According to an initiator of a location request (or a positioning request), there are the following several positioning request types:
(1) A mobile originated location request (MO-LR scenario) is a positioning request initiated by the terminal device, and requests location-related information of the terminal device from a serving public land mobile network (public land mobile network, PLMN).
(2) A mobile terminated location request (MT-LR scenario) is a positioning request initiated by a location service (location service, LCS) client or an application function inside or outside a serving public land mobile network PLMN, and requests location-related information of the terminal device from the serving PLMN.
(3) A network induced location request (NI-LR scenario) is a positioning request initiated by an access and mobility management function (access and mobility management function, AMF), and is used to obtain location information of the terminal device for some supervision services (for example, emergency calls from the terminal device).

### 5. Positioning Method Type

Positioning methods are mainly classified into the following types based on different nodes that perform positioning calculation and that are of the terminal device.
(1) In a UE-based positioning method, when assistance data is available, the terminal device performs location calculation of the terminal device, and the terminal device may further provide a measurement result related to a downlink signal.
(2) In a UE-assisted/LMF-based positioning method, the terminal device provides only a measurement result of a reference signal and does not perform location calculation. If assistance data is available, a location management function (location management function, LMF) is responsible for performing location calculation of the terminal device.
(3) In a standalone positioning method, when network assistance data unavailable, the terminal device performs downlink signal measurement and location calculation.

### 6. Integrity (Integrity)

According to the 3GPP TR 22.872 protocol, the integrity is a measure of the trust, and the trust refers to a degree of trust in accuracy of information provided by a navigation system. The integrity further includes an ability of providing timely and valid warnings to the terminal device when a positioning system does not fulfil a condition for an intended operation.

### 7. Integrity-Related Key Performance Indicators (Key Performance Indicator, KPI)

Currently, for a civil aviation positioning system, there are some related indicators for evaluating integrity of the system. These indicators are also applicable to the positioning system.
(1) Alert limit (alert limit, AL): A horizontal/vertical alert limit is a maximum allowable horizontal/vertical location error. If the horizontal/vertical location error is exceeded, the system is not applicable to an intended application. A value of the alert limit is usually preset, and is related to a specific positioning service.
(2) Time to alert (time to alert, TTA): A maximum allowable elapsed time from when the navigation system exceeds an allowable error range to when a device generates an alarm. A value of the time to alert is usually preset, and is related to a specific positioning service.
(3) Integrity risk (integrity risk, IR): A probability that a positioning error exceeds the alert limit, that is, a probability that the integrity of the system has a risk. A value of the integrity risk is usually also preset, and is related to a specific positioning service.
(4) Protection level (protection level, PL): A horizontal/vertical protection level refers to a statistical upper bound of a positioning error in a horizontal/vertical direction. The background of this indicator is as follows: In an actual operation process, an actual position of aircraft cannot be known, and therefore an actual positioning error cannot be known. Therefore, a new parameter needs to be provided to measure a possibility that the positioning error exceeds the alert limit. For example, if distribution of the positioning error can be obtained through measurement, the indicator can be calculated through Prob (PE<PL)=ε_{PL}, where ε_{PL} is a preset threshold and is also related to a specific positioning service.
(5) Error bound (error bounding, EB): The error bound is an upper bound of the positioning error, and is used to ensure positioning accuracy.
   8. Threat model
   Threat model:
(1) Anticipated events that the system needs to protect the user against.
(2) Conditions during which it needs to provide reliably safe confidence bounds.

The threat model requires:
(1) Each threat model needs to describe the specific nature of the threat, its magnitude, and its likelihood (namely, a probability of threat occurrence).
(2) The various threat models need to be comprehensive in describing all reasonable conditions.
(3) Only when it can be shown that each threat has been sufficiently addressed can, the system be deemed safe.

### Failure Mode:

The specific manner or way by which a failure occurs in terms of failure of the part, component, function, equipment, subsystem, or system under investigation.

### 9. Determining of an Operating Status of the System Based on the Integrity

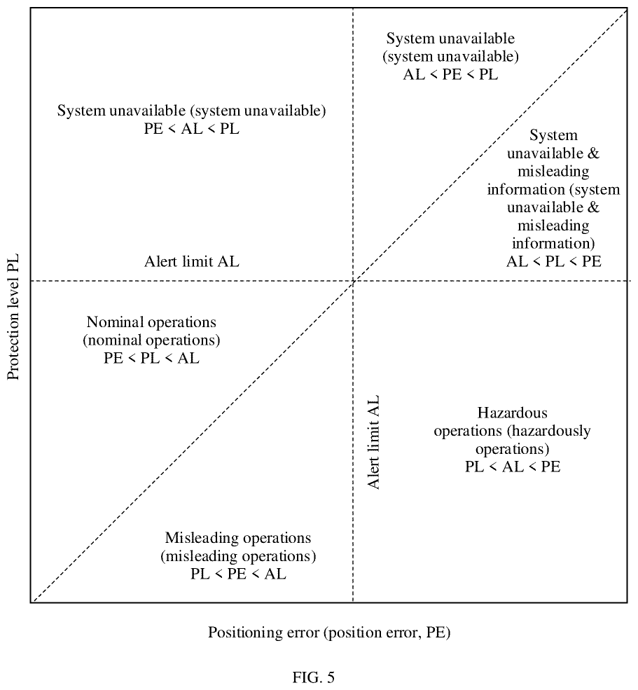

Currently, in a civil aviation system, an operating status of the system may be determined according to a Stanford diagram (Stanford diagram) (as shown in FIG. 5). As shown in FIG. 5, the operating status of the system may be determined by determining a magnitude relationship between a positioning error PE, an alert limit AL, a protection level PL, and the positioning error PE. The following conditions are included.
(1) When PE<AL<PL, the operating status of the system is “system unavailable (system unavailable)”.
(2) When AL<PE<PL, the operating status of the system is “system unavailable (system unavailable)”.
(3) When AL<PL<PE, the operating status of the system is “system unavailable & misleading information (system unavailable & misleading information)”.
(4) When PE<PL<AL, the operating status of the system is “normal operations (nominal operations)”.
(5) When PL<PE<AL, the operating status of the system is “misleading operations (misleading operations)”.
(6) When PL<AL<PE, the operating status of the system is “hazardous operations (hazardously operations)”.

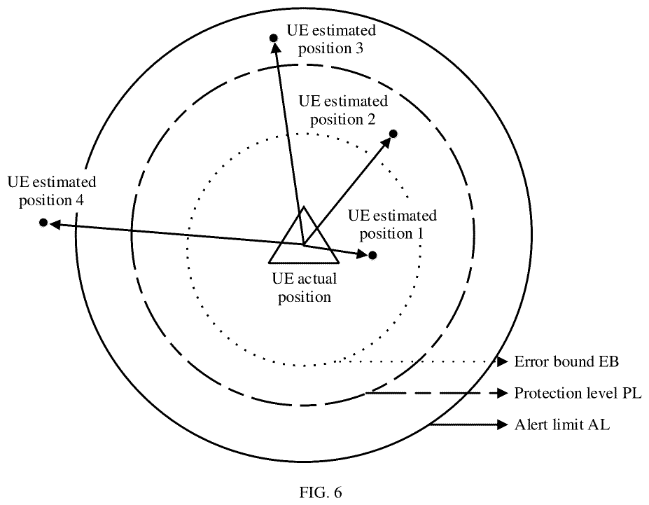

In this application, the six integrity-related operating statues in FIG. 5 are applied to a positioning system for locating the terminal device, and four simplified operating statuses may be obtained. As shown in FIG. 6, the following conditions are included.
(1) When PL>AL, that is, when the “protection level PL” of the terminal device exceeds the “alert limit AL”, the operating status of the positioning system is “system unavailable (system unavailable)”.
(2) When PE<PL<AL (at an estimated position 1 or 2), that is, when the “positioning error (position error, PE)” of the terminal device does not exceed an error bound corresponding to the “protection level PL”, and the “protection level PL” does not exceed the “alert limit AL”, the operating status of the positioning system is “nominal operations (nominal operations)”.
(3) When PL<PE<AL (at an estimated position 3), that is, when the “positioning error PE” of the terminal device exceeds an error bound corresponding to the “protection level PL” but does not exceed the “alert limit AL”, the operating status of the positioning system is “misleading operations (misleading operations).
(4) When PL<AL<PE (at an estimated position 4), that is, when the “protection level PL” of the terminal device does not exceed the “alert limit AL”, and the “positioning error PE” exceeds the “alert limit AL”, the operating status of the positioning system is “hazardous operations (hazardously operations)”.

It should be noted that the positioning error (position error, PE) in this application is a professional term, and specifically refers to a positioning error PE parameter related to the positioning integrity. To distinguish from a positioning error of a positioning system in a common sense, in this application, the professional noun positioning error PE is usually described as a “positioning error PE”, and a positioning error of the positioning system is described as a “system positioning error”. It should be understood that the “system positioning error” and the “positioning error of the positioning system” have same meanings in this application.

Currently, the LTE positioning protocol (TS 36.355) supports to report measurement quality (measurement quality) in information element (information element, IE), that is, provide location information (ProvideLocationInformation), but only a measurement error is discussed, and an error caused by another error source in the positioning process is not considered. In addition, for the existing system positioning error, the current standard lacks an alarm mechanism related to positioning errors of different systems, and cannot ensure the integrity (integrity) of the positioning system.

For the current situation that the positioning system lacks related mechanisms and implementation methods to ensure the integrity of the system, based on a definition of the integrity, this application provides a positioning integrity evaluation mechanism, and designs an alarm method when an integrity risk occurs.

According to the method for controlling the positioning system integrity provided in this application, when a system positioning error is large, an alarm level and an error source that correspond to the system positioning error may be indicated in a corresponding message, to ensure positioning accuracy in real time and ensure high reliability of the positioning system.

Before the method for controlling the positioning system integrity provided in this application is described, a hierarchical alarm mechanism used when an integrity risk occurs provided in this application is briefly described. A main idea of the hierarchical alarm mechanism is to send an alarm without waiting for the positioning system to be completely unavailable (for example, when the protection level (protection level, PL) in the integrity-related indicators exceeds the alert limit AL), and send a warning when the integrity risk is about to occur in the positioning system (for example, when the protection level PL approaches the alert limit AL). In this way, the integrity of the positioning system can be effectively ensured.

For example, based on FIG. 6, a proximity degree between the protection level PL and the alert limit AL in the integrity-related indicators is used as an example, and the four operating statuses in FIG. 6 are simplified into the following two operating statuses:
(1) When PL>AL, that is, when the “protection level PL” of the terminal device exceeds the “alert limit AL”, the operating status of the positioning system is “system unavailable (system unavailable)”.
(2) When PL<AL, that is, when the “protection level PL” of the terminal device does not exceed the “alert limit AL”, the operating status of the positioning system is “nominal operations (nominal operations)”, “misleading operations (misleading operations), or “hazardous operations (hazardously operations)”.

It should be noted that the foregoing determining condition does not include a case of being equal to. A person skilled in the art may define the case of being equal to according to a specific requirement. For example, the four operating statuses in FIG. 6 are simplified into the following two operating statues: (1) PL≥AL, and (2) PL<AL; or (1) PL>AL, and (2) PL≤AL. The case of being equal to is not limited in this application, and details are not described again.

It should be further noted that, when the operating status of the positioning system is “nominal operations (nominal operations)”, the system does not need to generate an alarm. Corresponding indication information may selectively include no-alarm information.

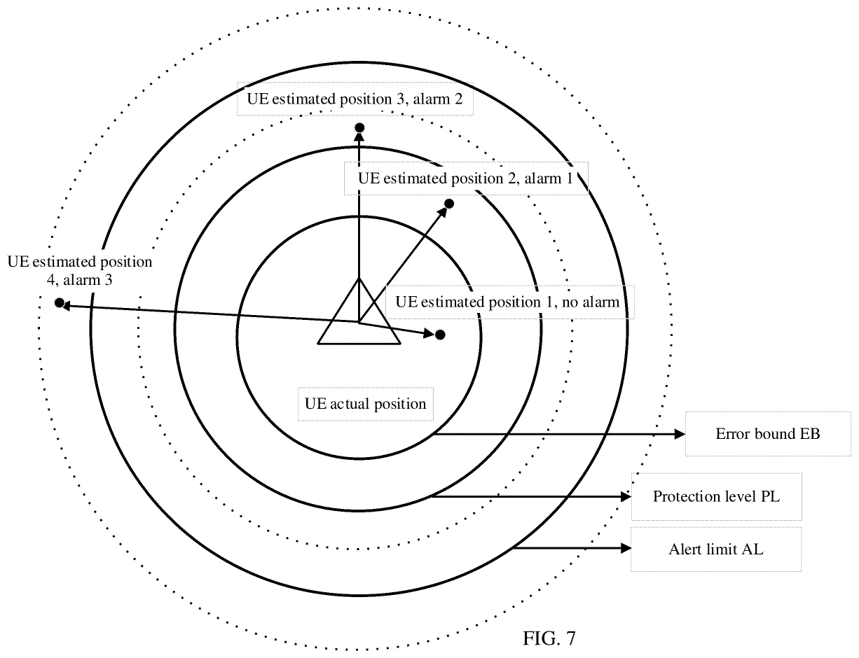

The following describes the hierarchical alarm mechanism provided in this application based on three alarm levels corresponding to the foregoing two operating statuses. FIG. 7 shows a hierarchical alarm mechanism based on the simplified two operating statues. As shown in FIG. 7, the hierarchical alarm mechanism is as follows:
(1) Alarm level 3 (System unavailable): When PL>AL, the operating status of the positioning system is “system unavailable (system unavailable)”.

In other words, when the protection level PL exceeds the alert limit AL, the positioning system is not suitable for continuing to provide a positioning service due to factors such as a large system positioning error, and the positioning system is unavailable (system unavailable). The alarm level may be determined as a sub-alarm level 3, that is, the alarm level 3, which is used to indicate that the positioning system cannot operate normally (System unavailable) at this time.
(2) Alarm level 2 (High risk): When AL-PL∈(0, Δg_{H}, the operating status of the positioning system is “high risk (High risk)”.

In other words, when the protection level PL approaches the alert limit AL, and a difference between the protection level PL and the AL does not exceed a first threshold Δ_{H}, a positioning service provided by the positioning system due to factors such as a large system positioning error may have low accuracy and poor reliability. The alarm level may be determined as a sub-alarm level 2, that is, the alarm level 2, which is used to indicate that the positioning system is in a high-risk state, and special attention needs to be paid to accuracy of a positioning result or the operating status of the positioning system needs to be adjusted in a timely manner.
(3) Alarm level 1 (Low risk): When AL-PL∈(Δ_{H}, Δ_{L}], the operating status of the positioning system is “low risk (Low risk)”.

In other words, when the protection level PL approaches the alert limit AL, and a difference between the protection level PL and the alert limit AL exceeds a first threshold Δ_{H} but does not exceed a second threshold Δ_{L}, and since the positioning system has a small system positioning error, the alarm level may be determined as a sub-alarm level 1, that is, the alarm level 1, which is used to indicate that the positioning system is in a low-risk state, and attention may need to be paid to accuracy of a positioning result or the operating status of the positioning system may need to be adjusted in a timely manner.

Values of the foregoing parameters are as follows:
(1) Protection level PL: The protection level PL may be obtained through measurement, calculation, or another manner. This is not limited in this application.
(2) Parameters such as the alert limit AL, the first threshold Δ_{H}, and the second threshold Δ_{L} are all related to a specific positioning service, and may be preset, or may also be carried in a positioning request, for example, carried in a QoS parameter.
(3) Positioning error (position error, PE): The PE is an error distribution/statistical value obtained by considering a plurality of error sources, and different positioning error PE values may be obtained according to different positioning methods. The positioning error PE may be obtained through measurement, calculation, or another manner. This is not limited in this application. An observed time difference of arrival (observed time difference of arrival, OTDOA) positioning method is used as an example. Possible error sources and error obtaining manners may be shown in the following Table 1:

TABLE 1

| Error | | |
|---|---|---|
| classification | Error source | Estimation method (if any) |
| Measurement | PRS | Opt 1: Obtain error distribution, such as |
| error | SINR/bandwidth/frequency/ | Gaussian distribution |
| | muting, PRS network | Opt 2: Obtain a variance of errors |
| | planning, and radio | Obtain from information element IE |
| | environment | ProvideLocationInformation-MeasQuality |
| Positioning | Related to a measurement | GDOP (Geometric dilution of precision) |
| algorithm error | error and selection of a | Based on a relative location between the |
| | positioning reference base | positioning reference base station and the |
| | station (a quantity of | UE, calculate at a node (LMF/UE) that is |
| | positioning reference base | responsible for performing positioning |
| | stations and a geometric | calculation |
| | location of UE) | |
| Radio | Multi-path, NLOS | Obtain from IE |
| propagation | | ProvideLocationInformation-MeasQuality |
| environment | | (the UE reports LOS/NLOS) |
| Synchronization | Synchronization error | Assuming to follow random distribution |
| error | between positioning reference | within a certain range |
| | base stations | Obtain from assistance information |
| | | carried in an NRPPa message |

For the positioning error PE, the protection level (protection level) and a corresponding integrity level (confidence level) may be reported in information element IE NR-MeasQuality [37.355 CR] to reflect the method for controlling the positioning integrity provided in this application. For example, features shown in Table 2 below may be added to the standard [37.355 CR].

TABLE 2
-- ASN1START
NR-MeasQuality-r16 ::= SEQUENCE {

| | |
|---|---|
| timingMeasQualityValue-r16 | INTEGER (0...31), |

```
  timingMeasQualityResolution-r16 ENUMERATED {mdot1, m1, m10, m30, ...},
  protectionLevel-r17 INTEGER (0...31),
```

| | |
|---|---|
| confidenceLevel-r17 (Opt.1) | INTEGER (0...127), |

```
Or
  confidenceLevel-r17 (Opt.2) ENUMERATED {percent99dot9/percentdot1,
percent99dot99/percentdot01, percent99dot999/percentdot001,
percent99dot9999/percentdot0001, ...},
  ...
}
-- ASN1STOP
```

Related descriptions thereof may be shown in the following Table 3.

TABLE 3
NR-MeasQuality field descriptions
protectionLevel-r17
This parameter provides the protection level corresponding to integrity.
confidenceLevel-r17
Opt 1: reuse “confidence” defined in TS 23.032, and the reserved bits
(101-127) denote the confidence level, e.g., 101-99.9%, 102-99.99%,
103-99.999%, 104-99.9999%, . . .
Opt 2: define a new parameter “confidenceLevel-r17” to provide the
confidence level/resolution used in the Value field.

When the positioning integrity of the positioning system meets one of the foregoing alarm conditions, an alarm level and/or error information of the positioning system need/needs to be indicated in a corresponding message, for example, the sub-alarm level 2 and/or information such as the error source that causes an error and the error value, to notify the positioning system to take corresponding measures for adjustment according to different situations of the positioning integrity and risk prompts corresponding to different alarm levels, so that a system integrity requirement can be met. Generally, according to different positioning scenarios (for example, MO-LR and MT-LR) and different positioning solutions (for example, LMF-based positioning and UE-based positioning), related alarm information and/or error information may be carried in different messages.

The foregoing example describes the hierarchical alarm mechanism by using the proximity degree between the protection level PL and the alert limit AL. The following describes a hierarchical alarm mechanism provided in this application by using a proximity degree between the protection level PL, the positioning error PE, and the alert limit AL in the integrity-related indicators as an example. Still using FIG. 7 as an example, the four operating statuses in FIG. 6 are simplified into the following two operating statuses:
(1) When PE<PL, that is, when the “positioning error PE” of the terminal device does not exceed an error bound corresponding to the “protection level PL”, the operating status of the positioning system is “nominal operations (nominal operation)”.
(2) When PE>PL, that is, when the “positioning error PE” of the terminal device exceeds an error bound corresponding to the “protection level PL”, the operating status of the positioning system is “misleading operations (misleading operations) or “hazardous operations (hazardously operations)”.

It should be noted that the foregoing determining condition does not include a case of being equal to. A person skilled in the art may define the case of being equal to according to a specific requirement. For example, the four operating statuses in FIG. 6 are simplified into the following two operating statues: (1) PE≤PL, and (2) PE>PL; or (1) PE<PL, and (2) PE≥PE. The case of being equal to is not limited in this application, and details are not described again.

It should be further noted that, when the operating status of the positioning system is “nominal operations (nominal operations)”, the system does not need to generate an alarm. Corresponding indication information may selectively include no-alarm information.

The following describes the hierarchical alarm mechanism provided in this application based on two alarm levels corresponding to the foregoing two operating statuses. The hierarchical alarm mechanism is as follows:
(1) Alarm level 2 (High risk) (at an estimated position 4): When PL<AL<PE, the operating status of the positioning system is “hazardous operations (hazardously operations)”.

In other words, when the “protection level PL” does not exceed the “alert limit AL”, and the “alert limit AL” does not exceed the “positioning error PE”, a positioning service provided by the positioning system due to factors such as a large system positioning error may have low accuracy and poor reliability. The alarm level may be determined as a sub-alarm level 2, that is, the alarm level 2, which is used to indicate that the positioning system is in a high-risk state, and special attention needs to be paid to accuracy of a positioning result or the operating status of the positioning system needs to be adjusted in a timely manner.
(2) Alarm level 1 (High risk) (at an estimated position 3): When PL<PE<AL, the operating status of the positioning system is “low risk (Low risk)”.

In other words, when the “protection level PL” does not exceed the “positioning error PE” and the “positioning error PE” does not exceed the “alert limit AL”, and since the positioning system has a small system positioning error, the alarm level may be determined as a sub-alarm level 1, that is, the alarm level 1, which is used to indicate that the positioning system is in a low-risk state, and attention may need to be paid to accuracy of a positioning result or the operating status of the positioning system may need to be adjusted in a timely manner.

For values of the foregoing related parameters, refer to the value descriptions in the foregoing embodiment in which the proximity degree between the protection level PL and the alert limit AL is used as an example, and details are not described herein again.

The foregoing example describes the hierarchical alarm mechanism by using the proximity degree between the protection level PL, the positioning error PE, and the alert limit AL. The following describes a hierarchical alarm mechanism provided in this application by using a proximity degree between the protection level PL and the positioning error PE in the integrity-related indicators as an example. Still using FIG. 7 as an example, the four operating statuses in FIG. 6 are simplified into the following two operating statuses:
(1) When PE<PL, that is, when the “positioning error PE” of the terminal device does not exceed an error bound corresponding to the “protection level PL”, the operating status of the positioning system is “nominal operations (nominal operation)”.
(2) When PL<PE, that is, when the “positioning error PE” of the terminal device exceeds an error bound corresponding to the “protection level PL”, the operating status of the positioning system is high risk or low risk.

It should be noted that the foregoing determining condition does not include a case of being equal to. A person skilled in the art may define the case of being equal to according to a specific requirement. For example, the four operating statuses in FIG. 6 are simplified into the following two operating statues: (1) PE≤PL, and (2) PL<PE; or (1) PE<PL, and (2) PL≤PE. The case of being equal to is not limited in this application, and details are not described again.

It should be further noted that, when the operating status of the positioning system is “nominal operations (nominal operations)”, the system does not need to generate an alarm. Corresponding indication information may selectively include no-alarm information.

The following describes the hierarchical alarm mechanism provided in this application based on two alarm levels corresponding to the foregoing two operating statuses. The hierarchical alarm mechanism is as follows:
(1) Alarm level 2 (High risk): When PE−PL∈(Δ_{K}, Δ_{F}], the operating status of the positioning system is “high risk (High risk)”.

In other words, when a difference between the protection level and the positioning error PE exceeds a third threshold Δ_{K} but does not exceed a fourth threshold Δ_{F}, a positioning service provided by the positioning system due to factors such as a large system positioning error may have low accuracy and poor reliability. The alarm level may be determined as a sub-alarm level 2, that is, the alarm level 2, which is used to indicate that the positioning system is in a high-risk state, and special attention needs to be paid to accuracy of a positioning result or the operating status of the positioning system needs to be adjusted in a timely manner.
(2) Alarm level 1 (Low risk): When PE−PL∈(0, Δ_{K}], the operating status of the positioning system is “low risk (Low risk)”.

In other words, when the protection level PL approaches the positioning error PE, and a difference between the protection level PL and the positioning error PE exceeds 0 and does not exceed the third threshold Δₖ, and since the positioning system has a small system positioning error, the alarm level may be determined as a sub-alarm level 1, that is, the alarm level 1, which is used to indicate that the positioning system is in a low-risk state, and attention may need to be paid to accuracy of a positioning result or the operating status of the positioning system may need to be adjusted in a timely manner.

For values of the foregoing related parameters, refer to the value descriptions in the foregoing embodiment in which the proximity degree between the protection level PL and the alert limit AL is used as an example, and details are not described herein again. Parameters such as the third threshold Δₖ and the fourth threshold Δ_{F} are all related to a specific positioning service, and may be preset, or may also be carried in a positioning request, for example, carried in a QoS parameter.

It should be noted that the sub-alarm level may be positively correlated to the alarm type, that is, a higher alarm level indicates a larger positioning error and a more dangerous system. Optionally, the sub-alarm level may also be negatively correlated to the alarm type. This is not limited in this application.

It should be understood that the foregoing embodiment is merely an implementation example of the hierarchical alarm mechanism. In an actual implementation process, there may be another implementation of the alarm mechanism. This is not specifically limited in this application.

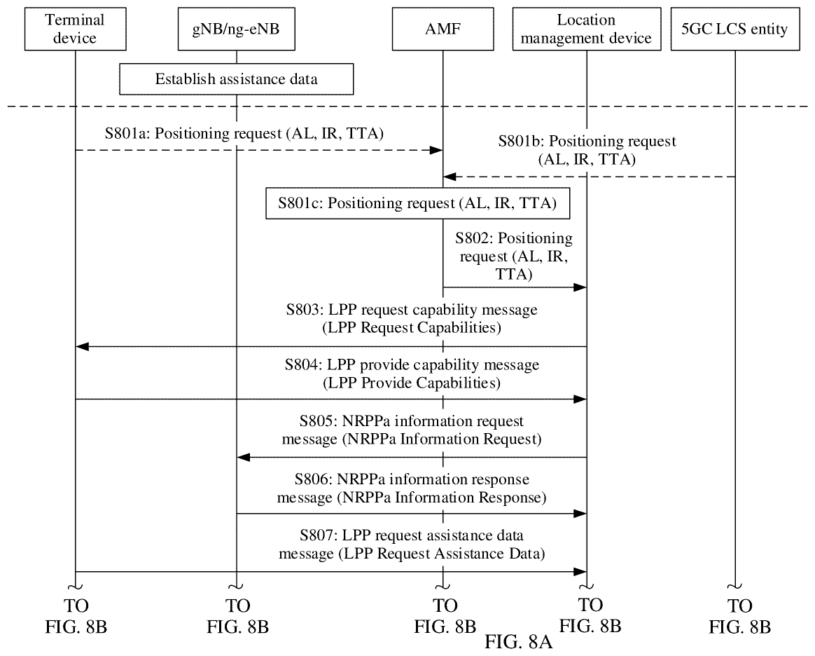

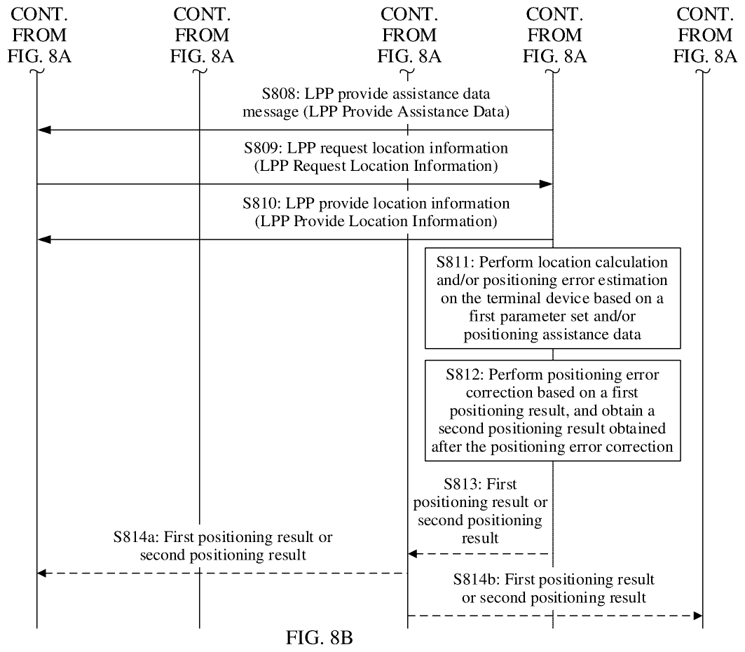

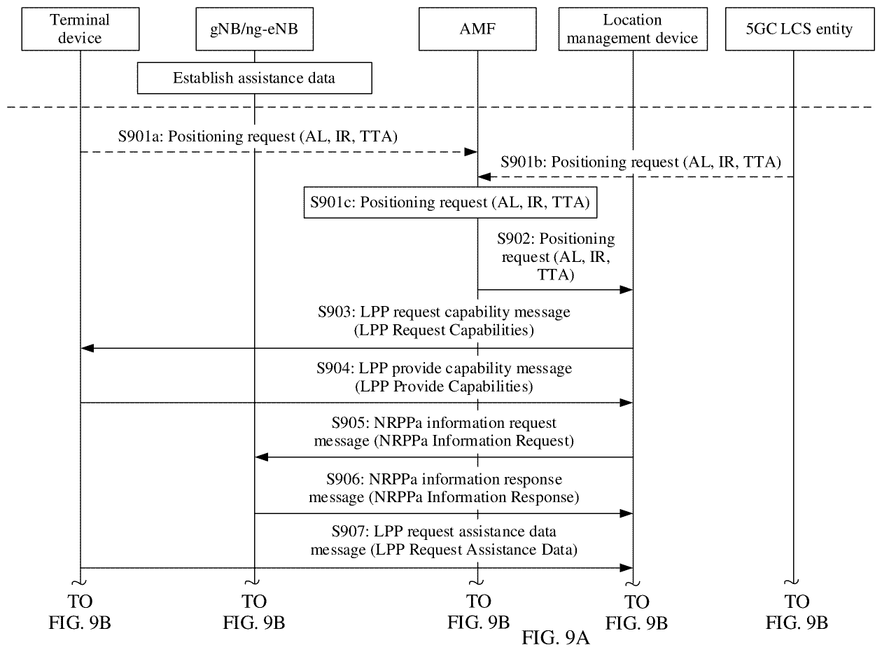

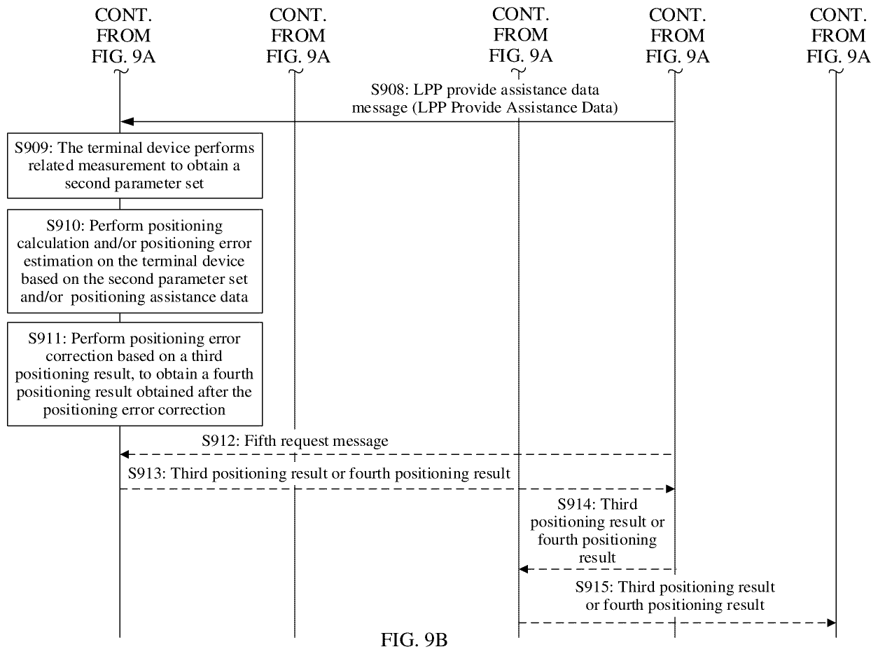

The following describes in detail the method for controlling the positioning integrity provided in embodiments of this application with reference to FIG. 8A and FIG. 8B and FIG. 9A and FIG. 9B.

It should be noted that, in the following embodiments of this application, names of messages or names of parameters in messages between devices are merely examples, and the messages or the parameters may have other names in specific implementations. This is not specifically limited in embodiments of this application.

FIG. 8A and FIG. 8B are a schematic flowchart of a method 800 for controlling positioning integrity according to an embodiment of this application. As shown in the figure, a location management device in FIG. 8A and FIG. 8B may correspond to the LMF in FIG. 3 or FIG. 4, or the LMC in FIG. 4. A terminal device in FIG. 8A and FIG. 8B may correspond to the UE in FIG. 3 or FIG. 4. A network device in FIG. 8A and FIG. 8B may correspond to the ng-eNB or the gNB in FIG. 3 or FIG. 4. An access and mobility management device in FIG. 8A and FIG. 8B may correspond to the AMF in FIG. 3 or FIG. 4. This embodiment describes a control method that is designed based on a UE-assisted/LMF-based positioning solution and that ensures the positioning integrity. This method may be applied to the foregoing MO-LR, MT-LR, or NI-LR positioning scenarios. In the UE-assisted/LMF-based positioning solution, if there is assistance data, the terminal device provides only a measurement result of a reference signal, and does not perform location calculation. The location management device performs location calculation of the terminal device. The method 800 for controlling the positioning integrity includes at least the following steps.

In this embodiment of this application, a positioning procedure may be initiated by using the following step S801a, S801b, or S801c.

S801a: The terminal device sends a positioning request to the access and mobility management device. Correspondingly, the access and mobility management device receives the positioning request from the terminal device. The positioning request requests to locate the terminal device.

In other words, the terminal device may actively initiate the procedure for locating the terminal device, and this step may be applied to the MO-LR positioning scenario.

The positioning request may also be referred to as a location service request in this application. Optionally, indication information related to the positioning integrity may be indicated in the positioning request. The indication information includes at least one or more of the following information: a protection level PL, an alert limit AL, an integrity risk IR, a time to alert TTA, an error source, an error value, an integrity level, a threat model, a threat occurrence rate, a failure mode, and the like. For example, one or more of the following information may be indicated in a QoS parameter of the positioning request: a protection level PL, an alert limit AL, an integrity risk IR, a time to alert TTA, an error source, an error value, an integrity level, a threat model, a threat occurrence rate, a failure mode, and the like.

S801b: A third-party device or function sends a positioning request to the access and mobility management device. Correspondingly, the access and mobility management device receives the positioning request from the third-party device or function. The positioning request requests to locate the terminal device.

In other words, the third-party device or function may actively initiate the procedure for locating the terminal device, and this step may be applied to the MT-LR positioning scenario.

Optionally, the third-party device or function may be a 5G core network (5G core, 5GC) location service (location services, LCS) entity, an LCS client, an application function inside/out of a serving PLMN, or the like. For example, the 5GC LCS entity in this embodiment of this application may be, for example, a gateway mobile positioning center (gateway mobile location center, GMLC).

Optionally, indication information related to the positioning integrity may be indicated in the positioning request. The indication information includes at least one or more of the following information: a protection level PL, an alert limit AL, an integrity risk IR, a time to alert TTA, an error source, an error value, an integrity level, a threat model, a threat occurrence rate, a failure mode, and the like. For example, one or more of the following information may be indicated in a QoS parameter of the positioning request: a protection level PL, an alert limit AL, an integrity risk IR, a time to alert TTA, an error source, an error value, an integrity level, a threat model, a threat occurrence rate, a failure mode, and the like.

S801c: The access and mobility management device determines some positioning service requirements of the terminal device (for example, the terminal device needs an emergency call), and triggers a positioning request.

In other words, the access and mobility management device may actively initiate the procedure for locating the terminal device, and this step may be applied to the NI-LR positioning scenario.

Optionally, indication information related to the positioning integrity may be indicated in the positioning request. The indication information includes at least one or more of the following information: a protection level PL, an alert limit AL, an integrity risk IR, a time to alert TTA, an error source, an error value, an integrity level, a threat model, a threat occurrence rate, a failure mode, and the like. For example, one or more of the following information may be indicated in a

QoS parameter of the positioning request: a protection level PL, an alert limit AL, an integrity risk IR, a time to alert TTA, an error source, an error value, an integrity level, a threat model, a threat occurrence rate, a failure mode, and the like.

It should be understood that the foregoing provides only examples of several manners

of initiating the positioning procedure, and there may be another manner of initiating the positioning procedure. This is not specifically limited in this embodiment of this application.

It should be noted that, before step S801a, S801b, or S801c in this embodiment of this application is performed, the method for controlling the positioning integrity provided in this application may further include offline steps, that is, steps that need to be performed before a positioning procedure of a terminal device is started. The offline steps that need to be performed before step S801a, S801b, or S801c are not specifically described in this embodiment of this application, and performing manners of these steps are not specifically limited either. A person skilled in the art may refer to an existing technique process.

Further, the method for controlling the positioning integrity provided in this embodiment of this application further includes the following steps S802 to S808.

S802: The access and mobility management device sends a positioning request to the location management device. Correspondingly, the location management device receives the positioning request from the access and mobility management device. The positioning request requests to locate the terminal device.

Optionally, indication information related to the positioning integrity may be indicated in the positioning request. The indication information includes at least one or more of the following information: a protection level PL, an alert limit AL, an integrity risk IR, a time to alert TTA, an error source, an error value, an integrity level, a threat model, a threat occurrence rate, a failure mode, and the like. For example, one or more of the following information may be indicated in a

QoS parameter of the positioning request: a protection level PL, an alert limit AL, an integrity risk IR, a time to alert TTA, an error source, an error value, an integrity level, a threat model, a threat occurrence rate, a failure mode, and the like.

The positioning request sent by the access and mobility management device to the location management device may be the positioning request in step S801a, S801b, or S801c.

S803: The location management device sends a first request message to the terminal device. Correspondingly, the terminal device receives the first request message from the location management device. The first request message requests a positioning capability of the terminal device.

Optionally, the first request message may be carried in an LTE positioning protocol (LTE positioning protocol, LPP) message, that is, the location management device may request the positioning capability from the terminal device by using an LPP message 1. For example, as shown in FIG. 8A and FIG. 8B, the LPP message 1 may be, for example, an LPP request capability (LPP Request Capabilities) message.

S804: The terminal device sends a first response message to the location management device. Correspondingly, the location management device receives the first response message from the terminal device. The first response message carries or includes the positioning capability of the terminal device.

Optionally, the first response message may be carried in the LTE positioning protocol (LTE positioning protocol, LPP) message, that is, the terminal device may send the positioning capability of the terminal device to the location management device by using an LPP message 2. For example, as shown in FIG. 8A and FIG. 8B, the LPP message 2 may be, for example, an LPP provide capability (LPP Provide Capabilities) message.

For example, in this embodiment of this application, the positioning capability of the terminal device may be, for example, whether to support control or measurement related to the positioning integrity, for example, measurement on one or more of parameters such as an alert limit AL, a time to alert TTA, or an integrity risk IR in integrity-related KPIs, or measurement on one or more of parameters such as an error source, an error value, an integrity level, a threat model, a threat occurrence rate, and a failure mode in integrity-related KPIs. This is not specifically limited in this embodiment of this application.

Optionally, different from the manner of obtaining the positioning capability of the terminal device in steps S803 and S804, in this embodiment of this application, the terminal device may actively send the positioning capability of the terminal device to the location management device without requesting. In other words, when the method for controlling the positioning integrity provided in this embodiment is performed, step S803 may be omitted. This is not specifically limited in this embodiment of this application.

S805: The location management device sends a second request message to a next-generation radio access network (next-generation radio access network, NG-RAN).

Correspondingly, the NG-RAN device receives the second request message from the location management device. The second request message requests positioning assistance data.

Optionally, the second request message may be carried in an NR positioning protocol (NR positioning protocol annex, NRPPa) message. In other words, the location management device may request the positioning assistance data from the NG-RAN device by using an NRPPa message 1. For example, as shown in FIG. 8A and FIG. 8B, the NRPPa message 1 may be, for example, an NRPPa information request (NRPPa Information Request) message.

For example, the positioning assistance data may be location information of a network device (for example, the ng-eNB or the gNB in FIG. 3, FIG. 4, or FIG. 8A and FIG. 8B) participating in positioning in the NG-RAN device, for example, a physical cell ID (physical cell IDs, PCIs), a global cell ID (global cell IDs, GCIs), a TP ID, PRS configuration information, or other assistance information related to the positioning integrity control. This is not limited in this application. In FIG. 8A and FIG. 8B, the ng-eNB or the gNB that participates in positioning is located in the NG-RAN device.

S806: The NG-RAN sends a second response message to the location management device. Correspondingly, the location management device receives the second response message from the NG-RAN device. The second response message carries or includes the positioning assistance data provided by the NG-RAN device for the location management device.

Optionally, the second response message may be carried in the NR positioning protocol (NR positioning protocol annex, NRPPa) message. In other words, the NG-RAN may send the positioning assistance data to the location management device by using an NRPPa message 2. For example, as shown in FIG. 8A and FIG. 8B, the NRPPa message 2 may be, for example, an NRPPa information response (NRPPa Information Response) message.

It should be noted that, in this embodiment of this application, the positioning assistance data provided by the NG-RAN device to the location management device may not only include the location information, the related configuration information, and the like of the network device that participates in positioning in the NG-RAN device, but also include other assistance data that can be provided by the NG-RAN device to the location management device and that is used to assist in positioning, for example, location information of another related device in the NG-RAN, or other assistance information related to the positioning integrity control. This is not specifically limited in this embodiment of this application.

Optionally, different from the manner of obtaining the positioning assistance data in steps S705 and S706, in this embodiment of this application, the NG-RAN device may actively send, without requesting, to the location management device by using the NRPPa message, the positioning assistance data that can be provided by the NG-RAN for the location management device. In other words, when the method for controlling the positioning integrity provided in this embodiment is performed, step S705 may be omitted. This is not specifically limited in this embodiment of this application.

S807: The terminal device sends a third request message to the location management device. Correspondingly, the location management device receives the third request message from the terminal device. The third request message requests positioning assistance data.

Optionally, the third request message may be carried in the LTE positioning protocol (LTE positioning protocol, LPP) message. In other words, the terminal device may request the positioning assistance data from the location management device by using an LPP message 3. For example, as shown in FIG. 8A and FIG. 8B, the LPP message 3 may be, for example, an LPP request assistance data (LPP Request Assistance Data) message.

S808: The location management device sends a third response message to the terminal device. Correspondingly, the terminal device receives the third response message from the location management device. The third response message carries or includes the positioning assistance data provided by the location management device for the terminal device.

Optionally, the third response message may be carried in the LTE positioning protocol (LTE positioning protocol, LPP) message. In other words, the location management device may send the positioning assistance data to the terminal device by using an LPP message 4. For example, as shown in FIG. 8A and FIG. 8B, the LPP message 4 may be, for example, an LPP provide assistance data (LPP Provide Assistance Data) message.

In this embodiment of this application, the positioning assistance data provided by the location management device for the terminal device not only includes the positioning assistance data provided by the NG-RAN device for the location management device, but also includes other assistance data (for example, assistance data that may be obtained by the location management device from another gateway) that can be provided by the location management device for the terminal device, such as a physical cell ID (physical cell IDs, PCIs), a global cell ID (global cell IDs, GCIs), a TP ID, PRS configuration information, or other assistance information related to the positioning integrity. This is not specifically limited in this embodiment of this application.

Optionally, different from the manner of obtaining the positioning assistance data in steps S807 and S808, in this embodiment of this application, the location management device may actively provide the positioning assistance data to the terminal device without requesting. In other words, when the method for controlling the positioning integrity provided in this embodiment is performed, step S807 may be omitted. This is not specifically limited in this embodiment of this application.

It should be noted that the foregoing steps S801 to S808 merely provide an example of a procedure in which a network device participates when the terminal device obtains the positioning assistance data in the method for controlling the positioning integrity. Certainly, in the method for controlling the positioning integrity provided in this application, the terminal device may need to obtain a plurality of groups of positioning assistance data. In this case, participation of a plurality of network devices may be required. For a processing and interaction procedure (not shown in FIG. 8A and FIG. 8B) of each network device, refer to the processing and the related interaction procedure of the NG-RAN device in the foregoing steps S801 to S808. Details are not described herein again.

Further, the positioning method provided in this embodiment of this application further includes the following steps S809 to S811.

S809: The location management device sends a fourth request message to the terminal device. Correspondingly, the terminal device receives the fourth request message from the location management device. The fourth request message requests a first parameter set.

Optionally, the fourth request message may be carried in the LTE positioning protocol (LTE positioning protocol, LPP) message, that is, the location management device may request a positioning measurement parameter from the terminal device by using an LPP message 5. For example, as shown in FIG. 8A and FIG. 8B, the LPP message 5 may be, for example, LPP request location information (LPP Request Location Information).

The first parameter set is a positioning measurement result obtained by the terminal device by measuring a reference signal. The first parameter set includes measurement information and/or error information that are/is related to location information of the terminal device, the error information is related to positioning integrity, and the error information includes at least one or more of the following information: a protection level, an error source, an error value, an integrity level, a threat model, a threat occurrence rate, and a failure mode.

S810: The terminal device sends a fourth response message to the location management device. Correspondingly, the location management device receives the fourth response message from the terminal device. The fourth response message carries or includes the first parameter set.

Optionally, the fourth response message may be carried in the LTE positioning protocol (LTE positioning protocol, LPP) message, that is, the terminal device may send the first parameter set to the location management device by using an LPP message 6. For example, as shown in FIG. 8A and FIG. 8B, the LPP message 6 may be, for example, LPP provide location information (LPP Provide Location Information).

Optionally, different from the manner of obtaining the first parameter set in steps S909 to S911, in this embodiment of this application, the terminal device may actively send the first parameter set to the location management device without requesting. In other words, when the method for controlling the positioning integrity provided in this embodiment is performed, step S909 may be omitted. This is not specifically limited in this embodiment of this application.

S811: The location management device performs location calculation and/or positioning error estimation on the terminal device based on the first parameter set and/or the positioning assistance data.

In a possible implementation, the location management device obtains a first positioning result based on the first parameter set and/or positioning assistance data, where the first positioning result includes location information and/or integrity information of the terminal device, and the integrity information includes the error information and/or alarm information. The error information is related to the positioning integrity, and the error information includes at least one or more of the following information: a protection level, an error source, an error value, a positioning error PE, an integrity level, a threat model, a threat occurrence rate, and a failure mode.

The alarm information includes a determining result obtained by comparing the first positioning result with a preset determining condition, and the determining result includes at least one or more of the following information: information about whether an alarm is required, an alarm level corresponding to the first positioning result, and the error information.

For example, the error information obtained by the location management device includes a measurement result of a protection level PL. The PL may be compared with related parameters of the positioning integrity: an alert limit AL, a time to alert TTA, an integrity risk IR, a positioning error PE, and the like, to obtain an evaluation of the positioning integrity, thereby ensuring the positioning integrity of the positioning system. The parameters such as the alert limit AL, the time to alert TTA, and the integrity risk IR are preset, and are related to a specific positioning service. The positioning error PE may be obtained through calculation, pre-configuration, or measurement.

It should be noted that the parameter related to the positioning integrity control, for example, the protection level PL, may be calculated by the terminal device, and then included in the first parameter set and sent to the location management device. Alternatively, the location management device may perform calculation based on another parameter in the first parameter set and/or the positioning assistance data. This is not limited in this application. If the parameter related to the positioning integrity control is calculated by the terminal device, the location management device may determine, based on a calculated value reported by the terminal device, whether an alarm is required. If the parameter related to the positioning integrity control is calculated by the location management device, the location management device first calculates the parameter related to the positioning integrity control, and then determines whether an alarm is required.

In a possible implementation, the determining result includes: if the first positioning result meets the preset determining condition, the determining result includes at least one or more of the following information: the alarm information, the alarm level corresponding to the first positioning result, and the error information; and if the first positioning result does not meet the preset determining condition, the determining result includes no-alarm information or does not include alarm information, that is, the determining result selectively includes no-alarm information.

For example, if the first positioning result meets a preset determining condition 1, the determining result includes the alarm information; or if the first positioning result meets a preset determining condition 1, the determining result includes the alarm level corresponding to the first positioning result; or if the first positioning result meets a preset determining condition 1, the determining result includes the error information; or if the first positioning result meets a preset determining condition 1, the determining result includes the alarm information and the alarm level corresponding to the first positioning result; or if the first positioning result meets a preset determining condition 1, the determining result includes the alarm information and the error information; or if the first positioning result meets a preset determining condition 1, the determining result includes the alarm information, the alarm level corresponding to the first positioning result, and the error information. If the first positioning result does not meet the preset determining condition 1, the determining result includes information about that no alarm is required, or the determining result does not include any alarm information, that is, the determining result selectively includes no-alarm information.

In a possible implementation, the determining result includes: if the first positioning result does not meet the preset determining condition, the determining result includes at least one or more of the following information: the alarm information, the alarm level corresponding to the first positioning result, and the error information; and if the first positioning result meets the preset determining condition, the determining result includes no-alarm information or does not include alarm information, that is, the determining result selectively includes no-alarm information. For example, if the first positioning result does not meet a preset determining condition

2, the determining result includes the alarm information; or if the first positioning result does not meet a preset determining condition 2, the determining result includes the alarm level corresponding to the first positioning result; or if the first positioning result does not meet a preset determining condition 2, the determining result includes the error information; or if the first positioning result does not meet a preset determining condition 2, the determining result includes the alarm information and the alarm level corresponding to the first positioning result; or if the first positioning result does not meet a preset determining condition 2, the determining result includes the alarm information and the error information; or if the first positioning result does not meet a preset determining condition 2, the determining result includes the alarm information, the alarm level corresponding to the first positioning result, and the error information. If the first positioning result meets the preset determining condition 2, the determining result includes information about that no alarm is required, or the determining result does not include any alarm information, that is, the determining result selectively includes no-alarm information.

In a possible implementation, the preset determining condition may include one or more sub-determining conditions, and the alarm level may also include one or more sub-alarm levels. One sub-alarm level corresponds to the one or more sub-determining conditions. For example, a first alarm level may be determined if a first sub-determining condition and a second sub-determining condition are met, or a first alarm level may be determined if a first sub-determining condition or a second sub-determining condition is not met. Alternatively, the one or more sub-alarm levels correspond to one sub-determining condition. For example, a first alarm level and a second alarm level may be determined if a first sub-determining condition is met, and the second alarm level may be determined if the second sub-determining condition is met again, or a first alarm level and a second alarm level may be determined if a first sub-determining condition is not met, and the second alarm level may be determined if the second sub-determining condition is not met again. The determining result includes at least one or more of the following information: information about whether an alarm is required, a sub-alarm level corresponding to the first positioning result, the error information, and the like.

For example, a proximity degree between the protection level PL and the alert limit AL in the integrity-related indicators is used as an example to perform positioning integrity estimation on the operating status of the positioning system, to determine whether an alarm needs to be generated. As shown in FIG. 6, an example in which the preset determining condition includes three sub-determining conditions and the alarm level includes three sub-alarm levels is used to describe the hierarchical alarm mechanism provided in this application. For example, the three sub-determining conditions may be as follows:

$$PL > AL ; \qquad ( 1 )$$

$$AL - PL ∈ ( 0 , {Δ}_{H} ] ; and \qquad ( 2 )$$

$$AL - PL ∈ ( {Δ}_{H} , {Δ}_{L} ] . \qquad ( 3 )$$

$$PL > AL . \qquad ( 1 )$$

When positioning integrity of the first positioning result meets the first sub-determining condition PL>AL, the operating status of the positioning system is “system unavailable (system unavailable)”. In other words, when the protection level PL exceeds the alert limit AL, the positioning system is not suitable for continuing to provide a positioning service due to factors such as a large system positioning error, and the positioning system is unavailable (system unavailable). The alarm level may be determined as a sub-alarm level 3 (the highest sub-alarm level), that is, the alarm level 3, which is used to indicate that the positioning system cannot operate normally (System unavailable) at this time. The determining result includes at least one or more of the following information: the alarm information, a third sub-alarm level corresponding to the first positioning result, and the error information.

$$AL - PL ∈ ( 0 , {Δ}_{H} ] . \qquad ( 2 )$$

When positioning integrity of the first positioning result meets the second sub-determining condition L−PL∈(0, Δ_{H}], the operating status of the positioning system is “high risk (High risk)”. In other words, when the protection level PL approaches the alert limit AL, and a difference between the protection level PL and the AL does not exceed a first threshold Δ_{H}, a positioning service provided by the positioning system due to factors such as a large system positioning error may have low accuracy and poor reliability. The alarm level may be determined as a sub-alarm level 2 (the second highest sub-alarm level), that is, the alarm level 2, which is used to indicate that the positioning system is in a high-risk state, and special attention needs to be paid to accuracy of a positioning result or the operating status of the positioning system needs to be adjusted in a timely manner. The determining result includes at least one or more of the following information: the alarm information, a second sub-alarm level corresponding to the first positioning result, and the error information.

$$AL - PL ∈ ( {Δ}_{H} , {Δ}_{L} ] . \qquad ( 3 )$$

When positioning integrity of the first positioning result meets the first sub-determining condition AL−PL∈(Δ_{H}, Δ_{L}], the operating status of the positioning system is “low risk (Low risk)”. In other words, when the protection level PL approaches the alert limit AL, and a difference between the protection level PL and the alert limit AL exceeds a first threshold Δ_{H} but does not exceed a second threshold Δ_{L}, and since the positioning system has a small system positioning error, the alarm level may be determined as a sub-alarm level 1 (the lowest sub-alarm level), that is, the alarm level 1, which is used to indicate that the positioning system is in a low-risk state, and attention may need to be paid to accuracy of a positioning result or the operating status of the positioning system may need to be adjusted in a timely manner. The determining result includes at least one or more of the following information: the alarm information, a first sub-alarm level corresponding to the first positioning result, and the error information.

The alert limit AL is a horizontal/vertical alert limit, and is a maximum allowable horizontal/vertical location error. If the horizontal error is exceeded, the system is not applicable to an intended application. A value of this indicator is usually preset, and is related to a specific positioning service. The protection level PL may be obtained through measurement, calculation, or another manner. This is not limited in this application. The positioning error PE is an error distribution/statistical value obtained by considering a plurality of error sources, and different positioning error PE values may be obtained according to different positioning methods. The positioning error PE may be obtained through measurement, calculation, or another manner. This is not limited in this application. The first threshold Δ_{H} and the second threshold Δ_{L} are all related to a specific positioning service, and may be preset, or may also be carried in a QoS parameter of a positioning request.

For example, the hierarchical alarm mechanism provided in this application may be further described by using a proximity degree between the protection level PL, the positioning error PE, and the alert limit AL in the integrity-related indicators as an example to perform positioning integrity estimation on the operating status of the positioning system, to determine whether an alarm needs to be generated. As shown in FIG. 8A and FIG. 8B, an example in which the preset determining condition includes two sub-determining conditions and the alarm level includes two sub-alarm levels is used to describe the hierarchical alarm mechanism provided in this application. For example, the two sub-determining conditions may be as follows:

$$PL < AL < PE ; and \qquad ( 1 )$$

$$PL < PE < AL . \qquad ( 2 )$$

$$PL < AL < PE . \qquad ( 1 )$$

When positioning integrity of the first positioning result meets the first sub-determining condition PL<AL<PE, the operating status of the positioning system is “high risk (hazardously operations)”. In other words, when the “protection level PL” does not exceed the “alert limit AL”, and the “alert limit AL” does not exceed the “positioning error PE”, a positioning service provided by the positioning system due to factors such as a large system positioning error may have low accuracy and poor reliability. The alarm level may be determined as a sub-alarm level 2, that is, the alarm level 2, which is used to indicate that the positioning system is in a high-risk state, and special attention needs to be paid to accuracy of a positioning result or the operating status of the positioning system needs to be adjusted in a timely manner. The determining result includes at least one or more of the following information: the alarm information, a second sub-alarm level corresponding to the first positioning result, and the error information.

$$PL < PE < AL . \qquad ( 2 )$$

When positioning integrity of the first positioning result meets the second sub-determining condition PL<PE<AL, the operating status of the positioning system is “low risk (Low risk)”.

In other words, when the “protection level PL” does not exceed the “positioning error PE” and the “positioning error PE” does not exceed the “alert limit AL”, and since the positioning system has a small system positioning error, the alarm level may be determined as a sub-alarm level 1, that is, the alarm level 1, which is used to indicate that the positioning system is in a low-risk state, and attention may need to be paid to accuracy of a positioning result or the operating status of the positioning system may need to be adjusted in a timely manner. The determining result includes at least one or more of the following information: the alarm information, a first sub-alarm level corresponding to the first positioning result, and the error information.

When PE<PL, that is, when the “positioning error PE” of the terminal device does not exceed an error bound corresponding to the “protection level PL”, the operating status of the positioning system is “nominal operations (nominal operation)”. In this case, the positioning system does not need to generate an alarm. Corresponding indication information may selectively include no-alarm information.

It should be understood that, the hierarchical alarm mechanism proposed in this application may alternatively be based on comparison of another positioning integrity related parameter or another correspondence form between a sub-alarm level and a sub-determining condition. This is not limited in this application.

The location management device performs location calculation and/or positioning error estimation on the terminal device based on the first parameter set and/or the positioning assistance data. The integrity information in the first positioning result is mainly used for positioning error estimation, and is compared with the preset determining condition based on the first positioning result. When the first positioning result meets or does not meet the preset determining condition, corresponding alarm information is provided. According to the method for controlling the positioning integrity provided in this application, a feasible implementation method is provided to ensure the positioning integrity in the positioning process, so that an alarm level and an error source can be indicated in a corresponding message when a positioning error is large.

Based on the positioning integrity control, optionally, the method for controlling the positioning integrity provided in this embodiment of this application further includes the following step S812:

S812: The location management device performs positioning error correction based on the first positioning result, and obtains a second positioning result obtained after the positioning error correction.

Optionally, the terminal device may perform positioning error correction on location information of the terminal device based on error information included in the first positioning result, for example, parameters such as an error source, an error value, or a positioning error PE, and obtain a second positioning result obtained after the positioning error correction, where the second positioning result includes location information and/or integrity information, of the terminal device, obtained after the positioning error correction.

Optionally, in this embodiment of this application, based on different manners of initiating the positioning procedure, the positioning method provided in this embodiment of this application may further include the following step S813.

S813: The location management device sends a first positioning result or a second positioning result to the access and mobility management device. Correspondingly, the access and mobility management device receives the first positioning result or the second positioning result from the terminal device of the location management device.

It should be noted that, if step S812 is not performed, the location management device sends a first positioning result to the access and mobility management device, where the first positioning result includes location information and/or integrity information of the terminal device, and the integrity information includes the error information and/or alarm information. The error information is related to positioning integrity, and the error information includes at least one or more of the following information: a protection level, an error source, an error value, a positioning error PE, an integrity level, a threat model, a threat occurrence rate, and a failure mode. The alarm information includes a determining result obtained by comparing the first positioning result with a preset determining condition, and the determining result includes at least one or more of the following information: information about whether an alarm is required, an alarm level corresponding to the first positioning result, and the error information.

If step S812 is performed, the location management device sends a second positioning result to the access and mobility management device, where the second positioning result includes location information and/or integrity information, of the terminal device, obtained after the positioning error correction, and the integrity information obtained after the positioning error correction includes error information and/or alarm information. The error information is related to the positioning integrity, and the error information includes at least one or more of the following information: a protection level, an error source, an error value, a positioning error PE, an integrity level, a threat model, a threat occurrence rate, and a failure mode. The alarm information includes a determining result obtained by comparing the first positioning result with a preset determining condition, and the determining result includes at least one or more of the following information: information about whether an alarm is required, an alarm level corresponding to the first positioning result, and the error information.

Optionally, in this embodiment of this application, if the positioning procedure is initiated by the terminal device or the third-party device or function such as the 5GC LCS entity (that is, step S802b is performed), the positioning method provided in this embodiment of this application further includes the following steps S814a and S814b.

S814a: The access and mobility management device sends a first positioning result or a second positioning result to the terminal device. Correspondingly, the terminal device receives the first positioning result or the second positioning result sent by the access and mobility management device.

It should be noted that, if step S812 is not performed, the access and mobility management device sends a first positioning result to the terminal device, where the first positioning result includes location information and/or integrity information of the terminal device. If step S812 is performed, the access and mobility management device sends a second positioning result to the terminal device, where the second positioning result includes location information and/or integrity information, of the terminal device, obtained after the positioning error correction.

S814b: The access and mobility management device sends a first positioning result or a second positioning result to the third-party device or function (for example, the 5GC LCS entity). Correspondingly, the third-party device or function receives the first positioning result or the second positioning result sent by the terminal device of the access and mobility management device.

It should be noted that, if step S812 is not performed, the access and mobility management device sends a first positioning result to the third-party device or function, where the first positioning result includes location information and/or integrity information of the terminal device. If step S812 is performed, the access and mobility management device sends a second positioning result to the third-party device or function, where the second positioning result includes location information and/or integrity information, of the terminal device, obtained after the positioning error correction.

In the foregoing embodiment, the method for controlling the positioning integrity is designed for the LMF-based positioning solution, and the hierarchical alarm mechanism is used for positioning errors of different systems, to ensure positioning accuracy in real time and ensure high reliability of the positioning system. First, ensuring the integrity of the positioning system is an important research point in R17. Currently, there are almost no evaluation and specific implementation methods for the integrity of the positioning system. This application provides a feasible implementation method for ensuring the positioning integrity of the positioning system. In addition, in this embodiment, the hierarchical alarm mechanism can be used for positioning errors of different systems, instead of sending an alarm only when an integrity risk occurs. In addition, in this embodiment, an error source may be clearly indicated in corresponding alarm information, which helps the positioning system to perform directional adjustment, and can effectively ensure the integrity of the positioning system. In addition, the location management device performs error correction based on the error information reported by the terminal device, to ensure positioning accuracy in real time.

FIG. 9A and FIG. 9B are a schematic flowchart of another method 900 for controlling positioning integrity according to an embodiment of this application. As shown in the figure, a location management device in FIG. 9A and FIG. 9B may correspond to the LMF in FIG. 3 or FIG. 4, or the LMC in FIG. 4. A terminal device in FIG. 9A and FIG. 9B may correspond to the UE in FIG. 3 or FIG. 4. A network device in FIG. 9A and FIG. 9B may correspond to the eNB or the gNB in FIG. 3 or FIG. 4. An access and mobility management device in FIG. 9A and FIG. 9B may correspond to the AMF in FIG. 3 or FIG. 4. Different from the UE-assisted/LMF-based positioning solution shown in FIG. 8A and FIG. 8B, this embodiment describes a control method that is designed based on a UE-based positioning solution and that ensures the positioning integrity. This method may be applied to the foregoing MO-LR, MT-LR, or NI-LR positioning scenarios. In the UE-based positioning solution, if there is assistance data, the terminal device provides a reference signal measurement result and calculates a location of the terminal device. The method 900 for controlling the positioning integrity includes at least the following steps.

In this embodiment of this application, a positioning procedure may be initiated by using the following step S901a, S901b, or S901c.

S901a: The terminal device sends a positioning request to the access and mobility management device. Correspondingly, the access and mobility management device receives the positioning request from the terminal device. The positioning request requests to locate the terminal device.

In other words, the terminal device may actively initiate the procedure for locating the terminal device, and this step may be applied to the MO-LR positioning scenario.

The positioning request may also be referred to as a location service request in this application. Optionally, indication information related to the positioning integrity may be indicated in the positioning request. The indication information includes at least one or more of the following information: a protection level PL, an alert limit AL, an integrity risk IR, a time to alert TTA, an error source, an error value, an integrity level, a threat model, a threat occurrence rate, a failure mode, and the like. For example, one or more of the following information may be indicated in a

QoS parameter of the positioning request: a protection level PL, an alert limit AL, an integrity risk IR, a time to alert TTA, an error source, an error value, an integrity level, a threat model, a threat occurrence rate, a failure mode, and the like.

S901b: A third-party device or function sends a positioning request to the access and mobility management device. Correspondingly, the access and mobility management device receives the positioning request from the third-party device or function. The positioning request requests to locate the terminal device.

In other words, the third-party device or function may actively initiate the procedure for locating the terminal device, and this step may be applied to the MT-LR positioning scenario.

Optionally, the third-party device or function may be a 5G core network (5G core, 5GC) location service (location services, LCS) entity, an LCS client, an application function inside/out of a serving PLMN, or the like. For example, the 5GC LCS entity in this embodiment of this application may be, for example, a gateway mobile positioning center (gateway mobile location center, GMLC).

Optionally, indication information related to the positioning integrity may be indicated in the positioning request. The indication information includes at least one or more of the following information: a protection level PL, an alert limit AL, an integrity risk IR, a time to alert TTA, an error source, an error value, an integrity level, a threat model, a threat occurrence rate, a failure mode, and the like. For example, one or more of the following information may be indicated in a QoS parameter of the positioning request: a protection level PL, an alert limit AL, an integrity risk

IR, a time to alert TTA, an error source, an error value, an integrity level, a threat model, a threat occurrence rate, a failure mode, and the like.

S901c: The access and mobility management device determines some positioning service requirements of the terminal device (for example, the terminal device needs an emergency call), and triggers a positioning request.

In other words, the access and mobility management device may actively initiate the procedure for locating the terminal device, and this step may be applied to the NI-LR positioning scenario.

Optionally, indication information related to the positioning integrity may be indicated in the positioning request. The indication information includes at least one or more of the following information: a protection level PL, an alert limit AL, an integrity risk IR, a time to alert TTA, an error source, an error value, an integrity level, a threat model, a threat occurrence rate, a failure mode, and the like. For example, one or more of the following information may be indicated in a QOS parameter of the positioning request: a protection level PL, an alert limit AL, an integrity risk IR, a time to alert TTA, an error source, an error value, an integrity level, a threat model, a threat occurrence rate, a failure mode, and the like.

It should be understood that the foregoing provides only examples of several manners of initiating the positioning procedure, and there may be another manner of initiating the positioning procedure. This is not specifically limited in this embodiment of this application.

It should be noted that, before step S901a, S901b, or S901c in this embodiment of this application is performed, the method for controlling the positioning integrity provided in this application may further include offline steps, that is, steps that need to be performed before a positioning procedure of a terminal device is started. The offline steps that need to be performed before step S901a, S901b, or S901c are not specifically described in this embodiment of this application, and performing manners of these steps are not specifically limited either. A person skilled in the art may refer to an existing technique process.

Further, the method for controlling the positioning integrity provided in this embodiment of this application further includes the following steps S902 to S908.

S902: The access and mobility management device sends a positioning request to the location management device. Correspondingly, the location management device receives the positioning request from the access and mobility management device. The positioning request requests to locate the terminal device.

Optionally, indication information related to the positioning integrity may be indicated in the positioning request. The indication information includes at least one or more of the following information: a protection level PL, an alert limit AL, an integrity risk IR, a time to alert TTA, an error source, an error value, an integrity level, a threat model, a threat occurrence rate, a failure mode, and the like. For example, one or more of the following information may be indicated in a QoS parameter of the positioning request: a protection level PL, an alert limit AL, an integrity risk IR, a time to alert TTA, an error source, an error value, an integrity level, a threat model, a threat occurrence rate, a failure mode, and the like.

The positioning request sent by the access and mobility management device to the location management device may be the positioning request in step S901a, S901b, or S901c.

S903: The location management device sends a first request message to the terminal device. Correspondingly, the terminal device receives the first request message from the location management device. The first request message requests a positioning capability of the terminal device.

Optionally, the first request message may be carried in an LTE positioning protocol (LTE positioning protocol, LPP) message, that is, the location management device may request the positioning capability from the terminal device by using an LPP message 1. For example, as shown in FIG. 9A and FIG. 9B, the LPP message 1 may be, for example, an LPP request capability (LPP Request Capabilities) message.

S904: The terminal device sends a first response message to the location management device. Correspondingly, the location management device receives the first response message from the terminal device. The first response message carries or includes the positioning capability of the terminal device.

Optionally, the first response message may be carried in the LTE positioning protocol (LTE positioning protocol, LPP) message, that is, the terminal device may send the positioning capability of the terminal device to the location management device by using an LPP message 2. For example, as shown in FIG. 9A and FIG. 9B, the LPP message 2 may be, for example, an LPP provide capability (LPP Provide Capabilities) message.

For example, in this embodiment of this application, the positioning capability of the terminal device may be, for example, whether to support control or measurement related to the positioning integrity, for example, measurement on one or more of parameters such as an alert limit AL, a time to alert TTA, or an integrity risk IR in integrity-related KPIs, or measurement on one or more of parameters such as an error source, an error value, an integrity level, a threat model, a threat occurrence rate, and a failure mode in integrity-related KPIs. This is not specifically limited in this embodiment of this application.

Optionally, different from the manner of obtaining the positioning capability of the terminal device in steps S903 and S904, in this embodiment of this application, the terminal device may actively send the positioning capability of the terminal device to the location management device without requesting. In other words, when the method for controlling the positioning integrity provided in this embodiment is performed, step S903 may be omitted. This is not specifically limited in this embodiment of this application.

S905: The location management device sends a second request message to a next-generation radio access network (next-generation radio access network, NG-RAN). Correspondingly, the NG-RAN device receives the second request message from the location management device. The second request message requests positioning assistance data.

Optionally, the second request message may be carried in an NR positioning protocol (NR positioning protocol annex, NRPPa) message. In other words, the location management device may request the positioning assistance data from the NG-RAN device by using an NRPPa message 1. For example, as shown in FIG. 9A and FIG. 9B, the NRPPa message 1 may be, for example, an NRPPa information request (NRPPa Information Request) message.

For example, the positioning assistance data may be location information of a network device (for example, the ng-eNB or the gNB in FIG. 3, FIG. 4, or FIG. 7) participating in positioning in the NG-RAN device, for example, a physical cell ID (physical cell IDs, PCIs), a global cell ID (global cell IDs, GCIs), a TP ID, PRS configuration information, or other assistance information related to the positioning integrity control. This is not limited in this application. In FIG. 9A and FIG. 9B, the ng-eNB or the gNB that participates in positioning is located in the NG-RAN device.

S906: The NG-RAN sends a second response message to the location management device. Correspondingly, the location management device receives the second response message from the NG-RAN device. The second response message carries or includes the positioning assistance data provided by the NG-RAN device for the location management device.

Optionally, the second response message may be carried in the NR positioning protocol (NR positioning protocol annex, NRPPa) message. In other words, the NG-RAN may send the positioning assistance data to the location management device by using an NRPPa message 2. For example, as shown in FIG. 9A and FIG. 9B, the NRPPa message 2 may be, for example, an NRPPa information response (NRPPa Information Response) message.

It should be noted that, in this embodiment of this application, the positioning assistance data provided by the NG-RAN device to the location management device may not only include the location information, the related configuration information, and the like of the network device that participates in positioning in the NG-RAN device, but also include other assistance data that can be provided by the NG-RAN device to the location management device and that is used to assist in positioning, for example, location information of another related device in the NG-RAN, or other assistance information related to the positioning integrity control. This is not specifically limited in this embodiment of this application.

Optionally, different from the manner of obtaining the positioning assistance data in steps S905 and S906, in this embodiment of this application, the NG-RAN device may actively send, without requesting, to the location management device by using the NRPPa message, the positioning assistance data that can be provided by the NG-RAN for the location management device. In other words, when the method for controlling the positioning integrity provided in this embodiment is performed, step S905 may be omitted. This is not specifically limited in this embodiment of this application.

S907: The terminal device sends a third request message to the location management device. Correspondingly, the location management device receives the third request message from the terminal device. The third request message requests positioning assistance data.

Optionally, the third request message may be carried in the LTE positioning protocol (LTE positioning protocol, LPP) message. In other words, the terminal device may request the positioning assistance data from the location management device by using an LPP message 3. For example, as shown in FIG. 9A and FIG. 9B, the LPP message 3 may be, for example, an LPP request assistance data (LPP Request Assistance Data) message.

S908: The location management device sends a third response message to the terminal device. Correspondingly, the terminal device receives the third response message from the location management device. The third response message carries or includes the positioning assistance data provided by the location management device for the terminal device.

Optionally, the third response message may be carried in the LTE positioning protocol (LTE positioning protocol, LPP) message. In other words, the location management device may send the positioning assistance data to the terminal device by using an LPP message 4. For example, as shown in FIG. 9A and FIG. 9B, the LPP message 4 may be, for example, an LPP provide assistance data (LPP Provide Assistance Data) message.

In this embodiment of this application, the positioning assistance data provided by the location management device for the terminal device not only includes the positioning assistance data provided by the NG-RAN device for the location management device, but also includes other assistance data (for example, assistance data that may be obtained by the location management device from another gateway) that can be provided by the location management device for the terminal device, such as a physical cell ID (physical cell IDs, PCIs), a global cell ID (global cell IDs, GCIs), a TP ID, PRS configuration information, or other assistance information related to the positioning integrity. This is not specifically limited in this embodiment of this application.

Optionally, different from the manner of obtaining the positioning assistance data in steps S907 and S908, in this embodiment of this application, the location management device may actively provide the positioning assistance data to the terminal device without requesting. In other words, when the method for controlling the positioning integrity provided in this embodiment is performed, step S707 may be omitted. This is not specifically limited in this embodiment of this application.

It should be noted that the foregoing steps S901 to S908 merely provide an example of a procedure in which a network device participates when the terminal device obtains the positioning assistance data in the method for controlling the positioning integrity. Certainly, in the method for controlling the positioning integrity provided in this application, the terminal device may need to obtain a plurality of groups of positioning assistance data. In this case, participation of a plurality of network devices may be required. For a processing and interaction procedure (not shown in FIG. 9A and FIG. 9B) of each network device, refer to the processing and the related interaction procedure of the NG-RAN device in the foregoing steps S901 to S908. Details are not described herein again.

Further, the positioning method provided in this embodiment of this application further includes the following steps S909 to S911.

S909: The terminal device performs related measurement to obtain a second parameter set.

The terminal device may measure a downlink reference signal, or obtain the second parameter set from the network device. For this step, refer to the conventional technology. This is not limited in this application.

S910: The terminal device performs positioning calculation and/or positioning error estimation on the terminal device based on the second parameter set and/or the positioning assistance data.

In a possible implementation, the terminal device obtains a third positioning result based on the second parameter set and/or positioning assistance data, where the third positioning result includes location information and/or integrity information of the terminal device, and the integrity information includes the error information and/or alarm information. The error information is related to positioning integrity, and includes at least one or more of the following information: a protection level, an error source, an error value, a positioning error PE, an integrity level, a threat model, a threat occurrence rate, and a failure mode. The alarm information includes a determining result obtained by comparing the third positioning result with a preset determining condition, and the determining result includes at least one or more of the following information: information about whether an alarm is required, an alarm level corresponding to the third positioning result, and the error information.

For example, the error information obtained by the terminal device includes a measurement result of a protection level PL. The PL may be compared with related parameters of the positioning integrity: an alert limit AL, a time to alert TTA, an integrity risk IR, a positioning error PE, and the like, to obtain an evaluation of the positioning integrity, thereby ensuring the positioning integrity of the positioning system. The parameters such as the alert limit AL, the time to alert TTA, and the integrity risk IR are preset, and are related to a specific positioning service. The positioning error PE may be obtained through calculation, pre-configuration, or measurement.

In a possible implementation, the determining result includes: if the third positioning result meets the preset determining condition, the determining result includes at least one or more of the following information: the alarm information, the alarm level corresponding to the third positioning result, and the error information; and if the third positioning result does not meet the preset determining condition, the determining result includes no-alarm information or does not include alarm information, that is, the determining result selectively includes no-alarm information.

For example, if the third positioning result meets a preset determining condition 3, the determining result includes the alarm information; or if the third positioning result meets a preset determining condition 3, the determining result includes the alarm level corresponding to the third positioning result; or if the third positioning result meets a preset determining condition 3, the determining result includes the error information; or if the third positioning result meets a preset determining condition 3, the determining result includes the alarm information and the alarm level corresponding to the third positioning result; or if the third positioning result meets a preset determining condition 3, the determining result includes the alarm information and the error information; or if the third positioning result meets a preset determining condition 3, the determining result includes the alarm information, the alarm level corresponding to the third positioning result, and the error information. If the third positioning result does not meet the preset determining condition 3, the determining result includes information about that no alarm is required, or the determining result does not include any alarm information, that is, the determining result selectively includes no-alarm information.

In a possible implementation, the determining result includes: if the third positioning result does not meet the preset determining condition, the determining result includes at least one or more of the following information: the alarm information, the alarm level corresponding to the third positioning result, and the error information; and if the third positioning result meets the preset determining condition, the determining result includes no-alarm information or does not include alarm information, that is, the determining result selectively includes no-alarm information.

For example, if the third positioning result does not meet a preset determining condition 4, the determining result includes the alarm information; or if the third positioning result does not meet a preset determining condition 4, the determining result includes the alarm level corresponding to the third positioning result; or if the third positioning result does not meet a preset determining condition 4, the determining result includes the error information; or if the third positioning result does not meet a preset determining condition 4, the determining result includes the alarm information and the alarm level corresponding to the third positioning result; or if the third positioning result does not meet a preset determining condition 4, the determining result includes the alarm information and the error information; or if the third positioning result does not meet a preset determining condition 4, the determining result includes the alarm information, the alarm level corresponding to the third positioning result, and the error information. If the third positioning result meets the preset determining condition 4, the determining result includes information about that no alarm is required, or the determining result does not include any alarm information, that is, the determining result selectively includes no-alarm information.

In a possible implementation, the preset determining condition may include one or more sub-determining conditions, and the alarm level may also include one or more sub-alarm levels. One sub-alarm level corresponds to the one or more sub-determining conditions. For example, a first alarm level may be determined if a first sub-determining condition and a second sub-determining condition are met, or a first alarm level may be determined if a first sub-determining condition or a second sub-determining condition is not met. Alternatively, the one or more sub-alarm levels correspond to one sub-determining condition. For example, a first alarm level and a second alarm level may be determined if a first sub-determining condition is met, and the second alarm level may be determined if the second sub-determining condition is met again, or a first alarm level and a second alarm level may be determined if a first sub-determining condition is not met, and the second alarm level may be determined if the second sub-determining condition is not met again. The determining result includes at least one or more of the following information: information about whether an alarm is required, a sub-alarm level corresponding to the third positioning result, the error information, and the like.

For example, a proximity degree between the protection level PL and the alert limit AL in the integrity-related indicators is used as an example to perform positioning integrity estimation on the operating status of the positioning system, to determine whether an alarm needs to be generated. As shown in FIG. 6, an example in which the preset determining condition includes three sub-determining conditions and the alarm level includes three sub-alarm levels is used to describe the hierarchical alarm mechanism provided in this application. For example, the three sub-determining conditions may be as follows:

$$PL > AL ; \qquad ( 1 )$$

$$AL - PL ∈ ( 0 , {Δ}_{H} ] ; and \qquad ( 2 )$$

$$AL - PL ∈ ( {Δ}_{H} , {Δ}_{L} ] . \qquad ( 3 )$$

$$PL > AL . \qquad ( 1 )$$

When positioning integrity of the third positioning result meets the first sub-determining condition PL>AL, the operating status of the positioning system is “system unavailable (system unavailable)”. In other words, when the protection level PL exceeds the alert limit AL, the positioning system is not suitable for continuing to provide a positioning service due to factors such as a large system positioning error, and the positioning system is unavailable (system unavailable). The alarm level may be determined as a sub-alarm level 3 (the highest sub-alarm level), that is, the alarm level 3, which is used to indicate that the positioning system cannot operate normally (System unavailable) at this time. The determining result includes at least one or more of the following information: the alarm information, a third sub-alarm level corresponding to the third positioning result, and the error information.

$$AL - PL ∈ ( 0 , {Δ}_{H} ] . \qquad ( 2 )$$

When positioning integrity of the third positioning result meets the second sub-determining condition L−PL∈(0, Δ_{H}], the operating status of the positioning system is “high risk (High risk)”. In other words, when the protection level PL approaches the alert limit AL, and a difference between the protection level PL and the AL does not exceed a first threshold Δ_{H}, a positioning service provided by the positioning system due to factors such as a large system positioning error may have low accuracy and poor reliability. The alarm level may be determined as a sub-alarm level 2 (the second highest sub-alarm level), that is, the alarm level 2, which is used to indicate that the positioning system is in a high-risk state, and special attention needs to be paid to accuracy of a positioning result or the operating status of the positioning system needs to be adjusted in a timely manner. The determining result includes at least one or more of the following information: the alarm information, a second sub-alarm level corresponding to the third positioning result, and the error information.

$$AL - PL ∈ ( {Δ}_{H} , {Δ}_{L} ] . \qquad ( 3 )$$

When positioning integrity of the third positioning result meets the first sub-determining condition AL−PL∈(Δ_{H}, Δ_{L}], the operating status of the positioning system is “low risk (Low risk)”. In other words, when the protection level PL approaches the alert limit AL, and a difference between the protection level PL and the alert limit AL exceeds a first threshold Δ_{H} but does not exceed a second threshold Δ_{H}, and since the positioning system has a small system positioning error, the alarm level may be determined as a sub-alarm level 1 (the lowest sub-alarm level), that is, the alarm level 1, which is used to indicate that the positioning system is in a low-risk state, and attention may need to be paid to accuracy of a positioning result or the operating status of the positioning system may need to be adjusted in a timely manner. The determining result includes at least one or more of the following information: the alarm information, a first sub-alarm level corresponding to the third positioning result, and the error information.

The alert limit AL is a horizontal/vertical alert limit, and is a maximum allowable horizontal/vertical location error. If the horizontal error is exceeded, the system is not applicable to an intended application. A value of this indicator is usually preset, and is related to a specific positioning service. The protection level PL may be obtained through measurement, calculation, or another manner. This is not limited in this application. The positioning error PE is an error distribution/statistical value obtained by considering a plurality of error sources, and different positioning error PE values may be obtained according to different positioning methods. The positioning error PE may be obtained through measurement, calculation, or another manner. This is not limited in this application. The first threshold Δ_{H} and the second threshold Δ_{L} are all related to a specific positioning service, and may be preset, or may also be carried in a QoS parameter of a positioning request.

For example, the hierarchical alarm mechanism provided in this application may be further described by using a proximity degree between the protection level PL, the positioning error PE, and the alert limit AL in the integrity-related indicators as an example to perform positioning integrity estimation on the operating status of the positioning system, to determine whether an alarm needs to be generated. As shown in FIG. 8A and FIG. 8B, an example in which the preset determining condition includes two sub-determining conditions and the alarm level includes two sub-alarm levels is used to describe the hierarchical alarm mechanism provided in this application. For example, the two sub-determining conditions may be as follows:

$$PL < AL < PE ; and \qquad ( 1 )$$

$$PL < PE < AL . \qquad ( 2 )$$

$$PL < AL < PE . \qquad ( 1 )$$

When positioning integrity of the third positioning result meets the first sub-determining condition PL<AL<PE, the operating status of the positioning system is “high risk (hazardously operations)”. In other words, when the “protection level PL” does not exceed the “alert limit AL”, and the “alert limit AL” does not exceed the “positioning error PE”, a positioning service provided by the positioning system due to factors such as a large system positioning error may have low accuracy and poor reliability. The alarm level may be determined as a sub-alarm level 2, that is, the alarm level 2, which is used to indicate that the positioning system is in a high-risk state, and special attention needs to be paid to accuracy of a positioning result or the operating status of the positioning system needs to be adjusted in a timely manner. The determining result includes at least one or more of the following information: the alarm information, a second sub-alarm level corresponding to the third positioning result, and the error information.

$$PL < PE < AL . \qquad ( 2 )$$

When positioning integrity of the third positioning result meets the second sub-determining condition PL<PE<AL, the operating status of the positioning system is “low risk (Low risk)”.

In other words, when the “protection level PL” does not exceed the “positioning error PE” and the “positioning error PE” does not exceed the “alert limit AL”, and since the positioning system has a small system positioning error, the alarm level may be determined as a sub-alarm level 1, that is, the alarm level 1, which is used to indicate that the positioning system is in a low-risk state, and attention may need to be paid to accuracy of a positioning result or the operating status of the positioning system may need to be adjusted in a timely manner. The determining result includes at least one or more of the following information: the alarm information, a first sub-alarm level corresponding to the third positioning result, and the error information.

When PE<PL, that is, when the “positioning error PE” of the terminal device does not exceed an error bound corresponding to the “protection level PL”, the operating status of the positioning system is “nominal operations (nominal operation)”. In this case, the positioning system does not need to generate an alarm. Corresponding indication information may selectively include no-alarm information.

It should be understood that, the hierarchical alarm mechanism proposed in this application may alternatively be based on comparison of another positioning integrity related parameter or another correspondence form between a sub-alarm level and a sub-determining condition. This is not limited in this application.

It should be understood that, in a specific implementation process of the solution provided in this application, error information may be selectively included in the alarm information based on different application scenarios or objectives. The error information usually includes at least one or more of the following information: a protection level, an error source, an error value, an integrity level, a threat model, a threat occurrence rate, and a failure mode. These parameter values included in the error information help the terminal device or another device participating in positioning to take a corresponding adjustment measure based on the error information.

It should be understood that, when locating the terminal device, in addition to the second parameter set and/or the positioning assistance data, the terminal device may further locate the terminal device based on other assistance data obtained from the location management device or another device. This is not specifically limited in this embodiment of this application.

Based on the positioning integrity control, optionally, the method for controlling the positioning integrity provided in this embodiment of this application further includes the following step S911:

S911: The terminal device performs positioning error correction based on the third positioning result, to obtain a fourth positioning result obtained after the positioning error correction.

Optionally, the terminal device may perform positioning error correction on location information of the terminal device based on error information included in integrity information in the third positioning result, for example, parameters such as an error source, an error value, or a positioning error PE, and obtain a fourth positioning result obtained after the positioning error correction, where the fourth positioning result includes location information and/or integrity information, of the terminal device, obtained after the positioning error correction.

Optionally, in this embodiment of this application, if the positioning procedure is not initiated by the terminal device (that is, step S901a is not performed), but is initiated by the access and mobility management device (that is, step S902c is performed) or the third-party device or function such as the 5GC LCS entity (that is, step S902b is performed), the positioning method provided in this embodiment of this application further includes the following steps S912 to S915.

S912: The location management device sends a fifth request message to the terminal device. Correspondingly, the terminal device receives the fifth request message from the location management device. The fifth request message requests location information and/or integrity information of the terminal device.

Optionally, the fifth request message may be carried in the LTE positioning protocol (LTE positioning protocol, LPP) message. In other words, the location management device may request the location information and/or the integrity information from the terminal device by using an LPP message 7. For example, as shown in FIG. 9A and FIG. 9B, the LPP message 7 may be, for example, LPP request location information (LPP Request Location Information).

It should be noted that if step S911 is not performed, the fifth request message may be used to request a third positioning result before the positioning error correction, where the third positioning result includes location information and/or integrity information of the terminal device, and the integrity information includes the error information and/or alarm information. The error information is related to positioning integrity, and includes at least one or more of the following information: a protection level, an error source, an error value, a positioning error PE, an integrity level, a threat model, a threat occurrence rate, and a failure mode. The alarm information includes a determining result obtained by comparing the third positioning result with a preset determining condition, and the determining result includes at least one or more of the following information: information about whether an alarm is required, an alarm level corresponding to the third positioning result, and the error information.

If step S911 is performed, the fifth request message is used to request a fourth positioning result obtained after the positioning error correction, where the fourth positioning result includes location information and/or integrity information, of the terminal device, obtained after the positioning error correction. The integrity information obtained after the positioning error correction includes error information and/or alarm information obtained after the positioning error correction. The error information is related to positioning integrity, and includes at least one or more of the following information: a protection level, an error source, an error value, a positioning error PE, an integrity level, a threat model, a threat occurrence rate, and a failure mode. The alarm information includes a determining result obtained by comparing the third positioning result with a preset determining condition, and the determining result includes at least one or more of the following information: information about whether an alarm is required, an alarm level corresponding to the fourth positioning result, and the error information.

S913: The terminal device sends a fifth response message to the location management device. Correspondingly, the location management device receives the fifth response message from the terminal device. The fifth response message carries or includes location information and/or integrity information of the terminal device.

Optionally, the fifth response message may be carried in the LTE positioning protocol (LTE positioning protocol, LPP) message. In other words, the terminal device may send the location information and/or the integrity information of the terminal device to the location management device by using an LPP message 8. For example, as shown in FIG. 9A and FIG. 9B, the LPP message 8 may be, for example, LPP provide location information (LPP Provide Location Information).

If step S911 is not performed, the location information and/or the integrity information of the terminal device that are/is carried or included in the fifth response message may be location information and/or integrity information, of the terminal device, before the positioning error correction, namely, the third positioning result. If step S911 is performed, the location information and/or the integrity information of the terminal device that are/is carried or included in the fifth response message may be the location information and/or the integrity information, of the terminal device, obtained after the positioning error correction, namely, the fourth positioning result.

Optionally, different from the manner of obtaining the location information and/or the integrity information of the terminal device in steps S912 and S913, in this embodiment of this application, the terminal device may actively provide the location information and/or the integrity information of the terminal device to the location management device without requesting. In other words, when the method for controlling the positioning integrity provided in this embodiment is performed, step S912 may be omitted. This is not specifically limited in this embodiment of this application.

S914: The location management device sends a third positioning result or a fourth positioning result to the access and mobility management device. Correspondingly, the access and mobility management device receives the third positioning result or the fourth positioning result from the location management device.

It should be noted that, if step S911 is not performed, the access and mobility management device sends a third positioning result to the third-party device or function, where the third positioning result includes location information and/or integrity information of the terminal device. If step S911 is performed, the access and mobility management device sends a fourth positioning result to the third-party device or function, where the fourth positioning result includes location information and/or integrity information, of the terminal device, obtained after the positioning error correction.

Optionally, in this embodiment of this application, if the positioning procedure is initiated by the third-party device or function such as the 5GC LCS entity (that is, step S702b is performed), the positioning method provided in this embodiment of this application further includes the following step S915:

S915: The access and mobility management device sends a third positioning result or a fourth positioning result to the third-party device or function (for example, the 5GC LCS entity). Correspondingly, the third-party device or function receives the third positioning result or the fourth positioning result from the access and mobility management device.

It should be noted that, if step S911 is not performed, the access and mobility management device sends a third positioning result to the third-party device or function, where the third positioning result includes location information and/or integrity information of the terminal device. If step S911 is performed, the access and mobility management device sends a fourth positioning result to the third-party device or function, where the fourth positioning result includes location information and/or integrity information, of the terminal device, obtained after the positioning error correction.

In the foregoing embodiment, the method for controlling the positioning integrity is designed for the UE-based positioning solution, and the hierarchical alarm mechanism is used for positioning errors of different systems, to ensure positioning accuracy in real time and ensure high reliability of the positioning system. First, ensuring the integrity of the positioning system is an important research point in R17. Currently, there are almost no evaluation and specific implementation methods for the integrity of the positioning system. This application provides a feasible implementation method for ensuring the positioning integrity of the positioning system. In addition, in this embodiment, the hierarchical alarm mechanism can be used for positioning errors of different systems, instead of sending an alarm only when an integrity risk occurs. In addition, in this embodiment, an error source may be clearly indicated in corresponding alarm information, which helps the positioning system to perform directional adjustment, and can effectively ensure the integrity of the positioning system. In addition, the terminal device may further perform error correction based on the error information, to ensure positioning accuracy in real time.

The foregoing describes the method embodiments provided in embodiments of this application, and the following describes apparatus embodiments provided in this application. It should be understood that descriptions of apparatus embodiments correspond to the descriptions of the method embodiments. Therefore, for content that is not described in detail, refer to the foregoing method embodiments. For brevity, details are not described herein again.

The foregoing mainly describes, from a perspective of interaction between devices, the solutions provided in embodiments of this application. It may be understood that, to implement the foregoing function, each device, for example, the location management device or the terminal device, includes a corresponding hardware structure and/or software module for performing each function. A person skilled in the art may be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In this embodiment of this application, the location management device or the terminal device may be divided into function modules based on the foregoing method examples. For example, function modules may be obtained through division based on corresponding functions, or two or more functions may be integrated into one processing module. The integrated module may be implemented in a form of hardware, or may be implemented in a form of a software functional module. It should be noted that, in this embodiment of this application, module division is an example, and is merely a logical function division. In actual implementation, another division manner may be used. An example in which each functional module is obtained through division based on each corresponding function is used below for description.

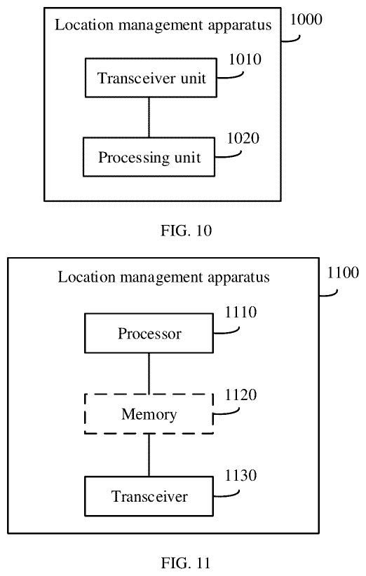

FIG. 10 is a schematic block diagram of a location management apparatus 1000 according to an embodiment of this application. The location management apparatus 1000 may be a location management device or a chip. The location management apparatus 1000 includes a transceiver unit 1010 and a processing unit 1020. The transceiver unit 1010 may communicate with the outside, and the processing unit 1010 is configured to process data. The transceiver unit 1010 may also be referred to as a communication interface or a communication unit. The location management apparatus 1000 may be configured to perform actions performed by the location management device in the method embodiment shown in FIG. 8A and FIG. 8B or FIG. 9A and FIG. 9B.

The location management apparatus 1000 may be configured to perform actions performed by the location management device in the foregoing method embodiments. The transceiver unit 1010 is configured to perform a receiving/sending-related operation on a location management device side in the foregoing method embodiments, and the processing unit 1020 is configured to perform a processing-related operation of the location management device in the foregoing method embodiments.

In an embodiment provided in this application, the transceiver unit 1010 and the processing unit 1020 are configured to perform related steps performed by the location management device in the method for controlling the positioning integrity shown in FIG. 8A and FIG. 8B.

For example, the transceiver unit 1010 is configured to receive a first message sent by a terminal device, where the first message includes a first parameter set, the first parameter set includes measurement information and/or error information that are/is related to location information of the terminal device, the error information is related to positioning integrity, and the error information includes at least one or more of the following information: a protection level, an error source, an error value, a positioning error PE, an integrity level, a threat model, a threat occurrence rate, and a failure mode.

The transceiver unit 1010 is further configured to send a first positioning result to an access and mobility management device.

The transceiver unit 1010 is further configured to send a second positioning result obtained after positioning error correction to the access and mobility management device.

The transceiver unit 1010 is further configured to receive a positioning request sent by the access and mobility management device, where the positioning request includes first indication information related to the positioning integrity, and the first indication information indicates one or more of the following information: an alert limit, an integrity risk, a time to alert, an error source, a threat model, a threat occurrence rate, a failure mode, an error value, and an integrity level.

The transceiver unit 1010 is further configured to: before receiving the first message sent by the terminal device, receive a second message sent by a next-generation radio access network device, where the second message includes positioning assistance data related to the location information of the terminal device.

The processing unit 1020 is configured to obtain a first positioning result based on the first parameter set and/or positioning assistance data, where the first positioning result includes location information and/or integrity information of the terminal device, the integrity information includes the error information and/or alarm information, the alarm information includes a determining result obtained by comparing the first positioning result with a preset determining condition, and the determining result includes at least one or more of the following information: information about whether an alarm is required, an alarm level corresponding to the first positioning result, and the error information.

In a possible implementation, the determining result includes: if the first positioning result meets the preset determining condition, the determining result includes at least one or more of the following information: the alarm information, the alarm level corresponding to the first positioning result, and the error information; and if the first positioning result does not meet the preset determining condition, the determining result selectively includes no-alarm information; or if the first positioning result does not meet the preset determining condition, the determining result includes at least one or more of the following information: the alarm information, the alarm level corresponding to the first positioning result, and the error information; and if the first positioning result meets the preset determining condition, the determining result selectively includes no-alarm information.

In a possible implementation, the preset determining condition includes one or more sub-determining conditions, and the alarm level includes one or more sub-alarm levels; and one sub-alarm level corresponds to the one or more sub-determining conditions; or the one or more sub-alarm levels correspond to one sub-determining condition.

The processing unit 1020 is further configured to perform positioning error correction based on the first positioning result, and obtain a second positioning result obtained after the positioning error correction, where the second positioning result includes location information and/or integrity information, of the terminal device, obtained after the positioning error correction.

For example, the transceiver unit 1010 and the processing unit 1020 may be configured to perform the following steps in the embodiment shown in FIG. 8A and FIG. 8B.

The transceiver unit 1010 is configured to receive a positioning request sent by the access and mobility management device. The positioning request requests to locate the terminal device. The positioning request may be the positioning request in step S801a, S801b, or S801c.

The transceiver unit 1010 is further configured to send a first request message to the terminal device. The first request message requests a positioning capability of the terminal device.

The transceiver unit 1010 is further configured to receive a first response message sent by the terminal device. The first response message carries or includes the positioning capability of the terminal device.

The transceiver unit 1010 is further configured to send a second request message to the next-generation radio access network (next-generation radio access network, NG-RAN). The second request message requests positioning assistance data.

The transceiver unit 1010 is further configured to receive a second response message sent by the next-generation radio access network. The second response message carries or includes the positioning assistance data provided by the NG-RAN device for the location management apparatus.

The transceiver unit 1010 is further configured to receive a third request message sent by the terminal device. The third request message requests positioning assistance data.

The transceiver unit 1010 is further configured to send a third response message to the terminal device. The third response message carries or includes the positioning assistance data provided by the location management apparatus for the terminal device.

The transceiver unit 1010 is further configured to send a fourth request message to the terminal device. The fourth request message requests a first parameter set.

The transceiver unit 1010 is further configured to receive a fourth response message sent by the terminal device. The fourth response message carries or includes the first parameter set.

The transceiver unit 1010 is further configured to send a first positioning result or a second positioning result to the access and mobility management device.

The processing unit 1020 is configured to perform location calculation and/or positioning error estimation on the terminal device based on the first parameter set and/or the positioning assistance data.

The processing unit 1020 is further configured to perform positioning error correction based on the first positioning result, and obtain a second positioning result obtained after the positioning error correction.

In another embodiment provided in this application, the transceiver unit 1010 and the processing unit 1020 are configured to perform related steps performed by the location management device in the method for controlling the positioning integrity shown in FIG. 9A and FIG. 9B.

The transceiver unit 1010 is configured to receive a third positioning result sent by the terminal device.

The transceiver unit 1010 is further configured to receive a fourth positioning result that is obtained after positioning error correction and that is sent by the terminal device.

The transceiver unit 1010 is further configured to send a third message to the terminal device, where the third message includes positioning assistance data related to location information of the terminal device, and the positioning assistance data is received by the location management device from a next-generation radio access network device.

For example, the transceiver unit 1010 and the processing unit 1020 may be configured to perform the following steps in the embodiment shown in FIG. 9A and FIG. 9B.

The transceiver unit 1010 is configured to receive a positioning request sent by an access and mobility management device. The positioning request requests to locate the terminal device. The positioning request may be the positioning request in step S901a, S901b, or S901c.

The transceiver unit 1010 is further configured to send a first request message to the terminal device. The first request message requests a positioning capability of the terminal device.

The transceiver unit 1010 is further configured to receive a first response message sent by the terminal device. The first response message carries or includes the positioning capability of the terminal device.

The transceiver unit 1010 is further configured to send a second request message to the next-generation radio access network (next-generation radio access network, NG-RAN). The second request message requests positioning assistance data.

The transceiver unit 1010 is further configured to receive a second response message

sent by the next-generation radio access network. The second response message carries or includes the positioning assistance data provided by the NG-RAN device for the location management apparatus.

The transceiver unit 1010 is further configured to receive a third request message sent by the terminal device. The third request message requests positioning assistance data.

The transceiver unit 1010 is further configured to send a third response message to the terminal device. The third response message carries or includes the positioning assistance data provided by the location management apparatus for the terminal device.

The transceiver unit 1010 is further configured to send a fifth request message to the terminal device. The fifth request message requests location information and/or integrity information of the terminal device.

The transceiver unit 1010 is further configured to receive a fifth response message sent by the terminal device. The fifth response message carries or includes location information and/or integrity information of the terminal device.

The transceiver unit 1010 is further configured to send a third positioning result or a fourth positioning result to the access and mobility management device.

All related content of the steps in the foregoing method embodiments may be cited in function descriptions of corresponding functional units. Details are not described herein again.

It should be understood that FIG. 10 is merely an example instead of a limitation. The location management device including the transceiver unit and the processing unit may not depend on the structure shown in FIG. 10.

When the terminal apparatus 1200 is a chip, the chip includes a transceiver unit and a processing unit. The transceiver unit may be an input/output circuit or a communication interface. The processing unit may be a processor, a microprocessor, or an integrated circuit that is integrated on the chip.

In this embodiment, the location management apparatus 1000 is presented in a form in which the functional units are obtained through division in an integrated manner. The “unit” herein may be an ASIC, a circuit, a processor that executes one or more software or firmware programs, a memory, an integrated logic circuit, and/or another component capable of providing the foregoing functions.

As shown in FIG. 11, an embodiment of this application further provides a location management apparatus 1100. The location management apparatus 1100 includes a processor 1110, a memory 1120, and a transceiver 1130. The memory 1120 stores a program. The processor 1110 is configured to execute the program stored in the memory 1120. Execution of the program stored in the memory 1120 enables the processor 1110 to perform related processing steps in the foregoing method embodiments. Execution of the program stored in the memory 1120 enables the processor 1110 to control the transceiver 1130 to perform the receiving/sending steps in the foregoing method embodiments. Optionally, the location management apparatus 1100 may include only the processor 1110 and the transceiver 1130, and does not include the memory 1120. This is not limited in this application.

In an implementation, the location management apparatus 1100 is configured to perform the actions performed by the location management device in the foregoing method embodiments shown in FIG. 8A and FIG. 8B. In this case, the execution of the program stored in the memory 1120 enables the processor 1110 to perform the processing steps on the location management device side in the foregoing method embodiments shown in FIG. 8A and FIG. 8B.

The execution of the program stored in the memory 1120 enables the processor 1110 to control the transceiver 1130 to perform the receiving/sending steps on the location management device side in the foregoing method embodiments shown in FIG. 8A and FIG. 8B. Optionally, the location management apparatus 1100 may include only the processor 1110 and the transceiver 1130, and does not include the memory 1120. This is not limited in this application.

In another implementation, the location management apparatus 1100 is configured to perform the actions performed by the location management device in the foregoing method embodiments shown in FIG. 9A and FIG. 9B. In this case, the execution of the program stored in the memory 1120 enables the processor 1110 to perform the processing steps on the location management device side in the foregoing method embodiments shown in FIG. 9A and FIG. 9B. The execution of the program stored in the memory 1120 enables the processor 1110 to control the transceiver 1130 to perform the receiving/sending steps on the location management device side in the foregoing method embodiments shown in FIG. 9A and FIG. 9B. Optionally, the location management apparatus 1100 may include only the processor 1110 and the transceiver 1130, and does not include the memory 1120. This is not limited in this application.

All related content of the steps in the foregoing method embodiments may be cited in function descriptions of corresponding functional components. Details are not described herein again.

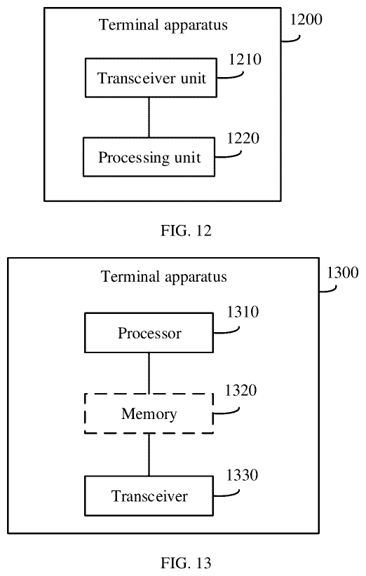

An embodiment of this application further provides a terminal apparatus 1200. The terminal apparatus 1200 may be a terminal device or a chip. FIG. 12 is a schematic block diagram of the terminal apparatus 1200 according to an embodiment of this application. The terminal apparatus 1200 includes a transceiver unit 1210 and a processing unit 1220. The transceiver unit 1210 may communicate with the outside, and the processing unit 1210 is configured to process data. The transceiver unit 1210 may also be referred to as a communication interface or a communication unit. The terminal apparatus 1200 may be configured to perform actions performed by the terminal device in the method embodiment shown in FIG. 8A and FIG. 8B or FIG. 9A and FIG. 9B.

The terminal apparatus 1200 may be configured to perform actions performed by the terminal device in the foregoing method embodiments. The transceiver unit 1210 is configured to perform a receiving/sending-related operation on a terminal device side in the foregoing method embodiments, and the processing unit 1020 is configured to perform a processing-related operation of the terminal device in the foregoing method embodiments.

In an embodiment provided in this application, the transceiver unit 1210 and the processing unit 1220 are configured to perform related steps performed by the terminal device in the method for controlling the positioning integrity shown in FIG. 8A and FIG. 8B.

For example, the transceiver unit 1210 is configured to send a first message to a location management device, where the first message includes a first parameter set, the first parameter set includes measurement information and/or error information that are/is related to location information of the terminal device, the error information is related to positioning integrity, and the error information includes at least one or more of the following information: a protection level, an error source, an error value, a positioning error PE, an integrity level, a threat model, a threat occurrence rate, and a failure mode.

For example, the transceiver unit 1210 and the processing unit 1220 may be configured to perform the following steps in the embodiment shown in FIG. 8A and FIG. 8B.

The transceiver unit 1210 is configured to send a positioning request sent by an access and mobility management device. The positioning request requests to locate the terminal device.

The transceiver unit 1210 is further configured to receive a first request message sent by the location management device. The first request message requests a positioning capability of the terminal device.

The transceiver unit 1210 is further configured to send a first response message to the location management device. The first response message carries or includes the positioning capability of the terminal device.

The transceiver unit 1210 is further configured to send a third request message to the location management device. The third request message requests positioning assistance data.

The transceiver unit 1210 is further configured to receive a third response message sent by the location management device. The third response message carries or includes the positioning assistance data provided by the location management device for the terminal device.

The transceiver unit 1210 is further configured to receive a fourth request message sent by the location management device. The fourth request message requests a first parameter set. The transceiver unit 1210 is further configured to send a fourth response message to the location management device. The fourth response message carries or includes the first parameter set.

The transceiver unit 1210 is further configured to receive a first positioning result or a second positioning result sent by the access and mobility management device. The transceiver unit 1210 is further configured to receive a fourth response message sent by the terminal device. The fourth response message carries or includes the first parameter set.

The transceiver unit 1210 is further configured to send a first positioning result or a second positioning result to the access and mobility management device.

The processing unit 1220 is configured to obtain the first parameter set.

In another embodiment provided in this application, the transceiver unit 1210 and the processing unit 1220 are configured to perform related steps performed by the terminal device in the method for controlling the positioning integrity shown in FIG. 9A and FIG. 9B.

The processing unit 1220 is configured to obtain a second parameter set, where the second parameter set includes measurement information and/or error information that are/is related to location information of the terminal device, the error information is related to positioning integrity, and the error information includes at least one or more of the following information: a protection level, an error source, an error value, a positioning error PE, an integrity level, a threat model, a threat occurrence rate, and a failure mode; where
the processing unit 1220 is further configured to obtain a third positioning result based on the second parameter set and/or positioning assistance data, where the third positioning result includes location information and/or integrity information of the terminal device, the integrity information includes the error information and/or alarm information, the alarm information includes a determining result obtained by comparing the third positioning result with a preset determining condition, and the determining result includes at least one or more of the following information: information about whether an alarm is required, an alarm level corresponding to the first positioning result, and the error information.

In a possible implementation, the determining result includes:
if the third positioning result meets the preset determining condition, the determining result includes at least one or more of the following information: the alarm information, an alarm level corresponding to the third positioning result, and the error information; and
if the third positioning result does not meet the preset determining condition, the determining result selectively includes no-alarm information; or
if the third positioning result does not meet the preset determining condition, the determining result includes at least one or more of the following information: the alarm information, an alarm level corresponding to the third positioning result, and the error information; and
if the third positioning result meets the preset determining condition, the determining result selectively includes no-alarm information.

In a possible implementation, the preset determining condition includes one or more sub-determining conditions, and the alarm level includes one or more sub-alarm levels.
one sub-alarm level corresponds to the one or more sub-determining conditions; or
the one or more sub-alarm levels correspond to one sub-determining condition.

The processing unit 1220 is further configured to perform positioning error correction based on the third positioning result, and obtain a fourth positioning result obtained after the positioning error correction, where the fourth positioning result includes location information and/or integrity information, of the terminal device, obtained after the positioning error correction.

The processing unit 1220 is further configured to obtain a second parameter set. The obtaining the second parameter set includes: obtaining the second parameter set through measurement, or from the next-generation radio access network device, or from a network device that participates in positioning and that includes a location management component.

The transceiver unit 1210 is configured to send a third positioning result to the location management device.

The transceiver unit 1210 is further configured to send a fourth positioning result obtained after the positioning error correction to the location management device.

The transceiver unit 1210 is further configured to send a positioning request to the access and mobility management device, where the positioning request includes first indication information related to the positioning integrity, and the first indication information indicates one or more of the following information: an alert limit, an integrity risk, a time to alert, an error source, a threat model, a threat occurrence rate, a failure mode, an error value, and an integrity level.

The transceiver unit 1210 is further configured to receive a third message sent by the location management device, where the third message includes positioning assistance data related to location information of the terminal device, and the positioning assistance data is received by the location management device from a next-generation radio access network device.

For example, the transceiver unit 1210 and the processing unit 1220 may be configured to perform the following steps in the embodiment shown in FIG. 9A and FIG. 9B.

The transceiver unit 1210 is configured to send a positioning request sent by an access and mobility management device. The positioning request requests to locate the terminal device.

The transceiver unit 1210 is further configured to receive a first request message sent by the location management device. The first request message requests a positioning capability of the terminal device.

The transceiver unit 1210 is further configured to send a first response message to the location management device. The first response message carries or includes the positioning capability of the terminal device.

The transceiver unit 1210 is further configured to send a third request message to the location management device. The third request message requests positioning assistance data.

The transceiver unit 1210 is further configured to receive a third response message sent by the location management device. The third response message carries or includes the positioning assistance data provided by the location management device for the terminal device.

The transceiver unit 1210 is further configured to receive a third request message sent by the terminal device. The third request message requests positioning assistance data.

The transceiver unit 1210 is further configured to receive a fifth request message sent by the location management device. The fifth request message requests location information and/or integrity information of the terminal device.

The transceiver unit 1210 is further configured to send a fifth response message to the location management device. The fifth response message carries or includes location information and/or integrity information of the terminal device.

The processing unit 1220 is configured to perform related measurement to obtain a second parameter set.

The processing unit 1220 is further configured to perform positioning calculation and/or positioning error estimation on the terminal device based on the second parameter set and/or the positioning assistance data.

The processing unit 1220 is further configured to perform positioning error correction based on the third positioning result, and obtain a fourth positioning result obtained after the positioning error correction.

All related content of the steps in the foregoing method embodiments may be cited in function descriptions of corresponding functional units. Details are not described herein again.

It should be understood that FIG. 12 is merely an example instead of a limitation. The terminal device including the transceiver unit and the processing unit may not depend on the structure shown in FIG. 12.

When the terminal apparatus 1200 is a chip, the chip includes a transceiver unit and a processing unit. The transceiver unit may be an input/output circuit or a communication interface. The processing unit may be a processor, a microprocessor, or an integrated circuit that is integrated on the chip.

In this embodiment, the terminal apparatus 1200 is presented in a form in which the functional units are obtained through division in an integrated manner. The “unit” herein may be an ASIC, a circuit, a processor that executes one or more software or firmware programs, a memory, an integrated logic circuit, and/or another component capable of providing the foregoing functions.

As shown in FIG. 13, an embodiment of this application further provides a terminal apparatus 1300. The terminal apparatus 1300 includes a processor 1310, a memory 1320, and a transceiver 1330. The memory 1320 stores a program. The processor 1310 is configured to execute the program stored in the memory 1320. Execution of the program stored in the memory 1320 enables the processor 1310 to perform related processing steps in the foregoing method embodiments. Execution of the program stored in the memory 1320 enables the processor 1310 to control the transceiver 1330 to perform the receiving/sending steps in the foregoing method embodiments. Optionally, the terminal apparatus 1300 may include only the processor 1310 and the transceiver 1330, and does not include the memory 1320. This is not limited in this application.

In an implementation, the terminal apparatus 1300 is configured to perform the actions performed by the terminal device in the foregoing method embodiments shown in FIG. 8A and FIG. 8B. In this case, the execution of the program stored in the memory 1320 enables the processor 1310 to perform the processing steps on the terminal device side in the foregoing method embodiments shown in FIG. 8A and FIG. 8B. The execution of the program stored in the memory 1320 enables the processor 1310 to control the transceiver 1330 to perform the receiving/sending steps on the terminal device side in the foregoing method embodiments shown in FIG. 8A and FIG. 8B. Optionally, the terminal apparatus 1300 may include only the processor 1310 and the transceiver 1330, and does not include the memory 1320.

In another implementation, the terminal apparatus 1300 is configured to perform the actions performed by the terminal device in the foregoing method embodiments shown in FIG. 9A and FIG. 9B. In this case, the execution of the program stored in the memory 1320 enables the processor 1310 to perform the processing steps on the terminal device side in the foregoing method embodiments shown in FIG. 9A and FIG. 9B. The execution of the program stored in the memory 1320 enables the processor 1310 to control the transceiver 1330 to perform the receiving/sending steps on the terminal device side in the foregoing method embodiments shown in FIG. 9A and FIG. 9B. Optionally, the terminal apparatus 1300 may include only the processor 1310 and the transceiver 1330, and does not include the memory 1320.

All related content of the steps in the foregoing method embodiments may be cited in function descriptions of corresponding functional components. Details are not described herein again.

An embodiment of this application further provides a communication system. The communication system includes at least the location management device in the embodiment shown in FIG. 8A and FIG. 8B or FIG. 9A and FIG. 9B and the terminal device in the embodiment shown in FIG. 8A and FIG. 8B or FIG. 9A and FIG. 9B, and further includes a network device participating in positioning, an access and mobility management device, and the like.

An embodiment of this application further provides a computer-readable storage medium. The computer-readable storage medium stores a computer program. When the computer program is executed by a computer, the computer is enabled to implement the method performed by the location management device in the method embodiment shown in FIG. 8A and FIG. 8B or FIG. 9A and FIG. 9B.

An embodiment of this application further provides a computer-readable storage medium. The computer-readable storage medium stores a computer program. When the computer program is executed by a computer, the computer is enabled to implement the method performed by the terminal device in the method embodiment shown in FIG. 8A and FIG. 8B or FIG. 9A and FIG. 9B.

An embodiment of this application further provides a computer program product including a computer program. When the computer program is executed by a computer, the computer is enabled to implement the method performed by the location management device in the method embodiment shown in FIG. 8A and FIG. 8B or FIG. 9A and FIG. 9B.

An embodiment of this application further provides a computer program product including a computer program. When the computer program is executed by a computer, the computer is enabled to implement the method performed by the terminal device in the method embodiment shown in FIG. 8A and FIG. 8B or FIG. 9A and FIG. 9B.

For explanations and beneficial effects of related content of any communication apparatus provided above, refer to a corresponding method embodiment provided above. Details are not described herein again.

In embodiments of this application, the terminal device, the location management device, the network device, or the like includes a hardware layer, an operating system layer running above the hardware layer, and an application layer running above the operating system layer. The hardware layer includes hardware such as a central processing unit (central processing unit, CPU), a memory management unit (memory management unit, MMU), and a memory (also referred to as a main memory). The operating system may be any one or more computer operating systems that implement service processing through a process (process), for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not specifically limited in embodiments of this application, provided that a program that records code of the method provided in embodiments of this application can be run to perform communication according to the method provided in embodiments of this application. For example, the method provided in embodiments of this application may be performed by the terminal device, the location management device, or the network device, or a function module that can invoke and execute the program in the terminal device, the location management device, or the network device.

In addition, aspects or features of this application may be implemented as a method, an apparatus, or a product that uses standard programming and/or engineering technologies. A “product” to which the methods provided in this application are applied covers a computer program that can be accessed from any computer-readable component, carrier, or medium. For example, the computer-readable medium may include but is not limited to: a magnetic storage component (for example, a hard disk, a floppy disk or a magnetic tape), an optical disc (for example, a compact disc (compact disc, CD), a digital versatile disc (digital versatile disc, DVD), a smart card and a flash memory component (for example, erasable programmable read-only memory (erasable programmable read-only memory, EPROM), a card, a stick, or a key drive). In addition, various storage media described in this specification may represent one or more devices and/or other machine-readable media that are configured to store information. The term “machine readable media” may include but is not limited to a radio channel, and various other media that can store, contain and/or carry instructions and/or data.

It should be understood that the processor mentioned in embodiments of this application may be a central processing unit (central processing unit, CPU), or the processor may be another general-purpose processor, a digital signal processor (digital signal processor, DSP), an application-specific integrated circuit (application-specific integrated circuit, ASIC), a field programmable gate array (field programmable gate array, FPGA), another programmable logic device, a discrete gate or transistor logic device, a discrete hardware component, or the like. The general-purpose processor may be a microprocessor, or the processor may be any conventional processor or the like.

It may be understood that the memory mentioned in embodiments of this application may be a volatile memory or a nonvolatile memory, or may include a volatile memory and a nonvolatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM) and is used as an external cache. For example but not limitation, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus dynamic random access memory (direct rambus RAM, DR RAM).

It should be noted that when the processor is a general-purpose processor, a DSP, an ASIC, an FPGA or another programmable logic device, a discrete gate or transistor logic device, or a discrete hardware component, the memory (storage module) is integrated into the processor.

It should be noted that the memory described in this specification aims to include but is not limited to these memories and any memory of another proper type.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed operating process of the foregoing system, apparatus, and unit, refer to a corresponding process in the foregoing method embodiments, and details are not described herein again.

In several embodiments provided in this application, it should be understood that the disclosed system, apparatus, and method may be implemented in another manner. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a readable storage medium, and includes several instructions for instructing a computer device (which may be a personal computer, a server, or a network device) to perform all or some of the steps of the methods described in embodiments of this application. The foregoing readable storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and/or the specification.

What is claimed is:

1. A method for controlling positioning integrity, applied to a location management device or a chip in the location management device, comprising:
sending a Long Term Evolution Positioning Protocol (LPP) request location information message to a terminal device;
receiving an LPP provide location information message from the terminal device, wherein the LPP provide location information message includes location information and integrity information of the terminal device; the integrity information includes a protection level, wherein the protection level comprises a horizontal protection level and/or a vertical protection level; wherein the horizontal protection level is a statistical upper bound of positioning error in a horizontal direction, and the vertical protection level is a statistical upper bound of positioning error in a vertical direction.

2. The method according to claim 1, wherein before receiving the LPP provide location information message from the terminal device, the method further comprises:
receiving a positioning request from an access and mobility management device, wherein the positioning request includes first indication information related to the positioning integrity, and the first indication information indicates one or more of the following information: an alert limit, an integrity risk, a time to alert, an error source, a threat model, a threat occurrence rate, a failure mode, an error value, and an integrity level.

3. The method according to claim 1, wherein before receiving the LPP provide location information message from the terminal device, the method further comprises:
receiving a second message from a next-generation radio access network device, wherein the second message includes positioning assistance data related to the location information of the terminal device.

4. The method according to claim 1, wherein before receiving the LPP location information message from the terminal device, the method further comprises:
receiving a positioning capability from the terminal device, wherein the positioning capability indicates whether the terminal device supports control or measurement related to positioning integrity.

5. The method according to claim 4, wherein the control or measurement related to positioning integrity includes one or more of the following: an alarm limit, an integrity risk, a time to alert, an error source, a threat model, a threat occurrence rate, a failure mode, an error value, and an integrity level.

6. A positioning integrity control method, applied to a terminal device or a chip in the terminal device, comprising:
obtaining a parameter set, wherein the parameter set includes measurement information related to the location information of the terminal device.
obtaining the location information and integrity information of the terminal device based on the parameter set and positioning assistance data; the integrity information includes a protection level, wherein the protection level comprises a horizontal protection level and/or a vertical protection level; wherein the horizontal protection level is a statistical upper bound of the positioning error in the horizontal direction, and the vertical protection level is a statistical upper bound of the positioning error in the vertical direction;
sending the location information and integrity information of the terminal device to the location management device through a Long Term Evolution Positioning Protocol (LPP) provide location information message.

7. The method according to claim 6, further comprising:
receiving an LPP request location information message from the location management device.

8. The method according to claim 6, wherein before obtaining the parameter set, the method further comprises:
sending a positioning request to an access and mobility management device, wherein the positioning request includes first indication information related to the positioning integrity, and the first indication information is used to indicate one or more of the following information: alert limit, integrity risk, reminder time, error source, threat model, threat occurrence probability, failure mode, error value, integrity level.

9. The method according to claim 6, wherein before obtaining the parameter set, the method further comprises:
receiving a third message from the location management device, wherein the third message includes positioning assistance data related to the location information of the terminal device, and the positioning assistance data is received by the location management device from a next-generation radio access network device.

10. The method according to claim 6, wherein before obtaining the parameter set, the method further comprises:
sending a positioning capability to the location management device, wherein the positioning capability indicates whether the terminal device supports control or measurement related to positioning integrity.

11. The method according to claim 10, wherein the control or measurement related to positioning integrity includes one or more of the following: an alarm limit, an integrity risk, a time to alert, an error source, a threat model, a threat occurrence rate, a failure mode, an error value, and an integrity level.

12. An apparatus, at least one processor coupled to at least one memory storing instructions and configured to execute the instructions to cause the apparatus to perform:
obtaining a parameter set, wherein the parameter set includes measurement information related to the location information of a terminal device.
obtaining the location information and integrity information of the terminal device based on the parameter set and positioning assistance data; the integrity information includes a protection level, wherein the protection level comprises a horizontal protection level and/or a vertical protection level; wherein the horizontal protection level is a statistical upper bound of the positioning error in the horizontal direction, and the vertical protection level is a statistical upper bound of the positioning error in the vertical direction;
sending the location information and integrity information of the terminal device to the location management device through a Long Term Evolution Positioning Protocol (LPP) provide location information message.

13. The apparatus according to claim 12, the apparatus is further caused to perform:
receiving an LPP request location information message from the location management device.

14. The apparatus according to claim 12, wherein before obtaining the parameter set, the apparatus is further caused to perform:
sending a positioning request to an access and mobility management device, wherein the positioning request includes first indication information related to the positioning integrity, and the first indication information is used to indicate one or more of the following information: alert limit, integrity risk, reminder time, error source, threat model, threat occurrence probability, failure mode, error value, integrity level.

15. The apparatus according to claim 12, wherein before obtaining the parameter set, the apparatus is further caused to perform:
receiving a third message from the location management device, wherein the third message includes positioning assistance data related to the location information of the terminal device, and the positioning assistance data is received by the location management device from a next-generation radio access network device.

16. The apparatus according to claim 12, wherein before obtaining the parameter set, the apparatus is further caused to perform:
sending a positioning capability to the location management device, wherein the positioning capability indicates whether the terminal device supports control or measurement related to positioning integrity.

17. The apparatus according to claim 16, wherein the control or measurement related to positioning integrity includes one or more of the following: an alarm limit, an integrity risk, a time to alert, an error source, a threat model, a threat occurrence rate, a failure mode, an error value, and an integrity level.
